(19) United States
(12) Patent Application Publication
(10) Pub. No.: US 2026/0351774 A1
(43) Pub. Date: Nov. 5, 2026

(54) ENERGY STORAGE POWER SUPPLY

(71) Applicant: SHENZHEN HELLO TECH ENERGY CO., LTD, Shenzhen (CN)

(72) Inventors: Chao HU, Shenzhen (CN); Yongjun CHEN, Shenzhen (CN); Hongliang ZHAO, Shenzhen (CN); Gaosong SHEN, Shenzhen (CN); Zhongwei SUN, Shenzhen (CN)

(21) Appl. No.: 19/726,874

(22) Filed: Jun. 30, 2026

Related U.S. Application Data
(63) Continuation of application No. PCT/CN2025/100507, filed on Jun. 11, 2025.

(30) Foreign Application Priority Data
Jun. 5, 2025 (CN) 202510744796.X
Jun. 5, 2025 (CN) 202510749515.X
Jun. 5, 2025 (CN) 202510750969.9
Jun. 5, 2025 (CN) 202510751139.8
Jun. 5, 2025 (CN) 202510753101.4
Jun. 5, 2025 (CN) 202521140619.2
Jun. 5, 2025 (CN) 202521143965.6
Jun. 5, 2025 (CN) 202521145632.7
Jun. 5, 2025 (CN) 202521145860.4
Jun. 5, 2025 (CN) 202521146766.0
Jun. 5, 2025 (CN) 202521149427.8

(51) Int. Cl. H01M 50/287; H01M 10/42; H01M 10/658; H01M 50/213

(52) U.S. Cl. CPC H01M 50/287; H01M 10/425; H01M 10/658; H01M 50/213; H01M 2010/4271

(57) ABSTRACT

Provided is an energy storage power supply. The energy storage power supply includes a shell, a circuit board module, and a battery module. The shell includes a first housing and a second housing detachably connected to the first housing. The first housing and the second housing define an accommodation chamber. The circuit board module includes an inverter circuit. The circuit board module is fixedly mounted at the first housing and is located in the accommodation chamber. The battery module is fixedly mounted at the second housing and is located in the accommodation chamber. The battery module is electrically connected to the circuit board module.

### CROSS-REFERENCE TO RELATED APPLICATION

This application is a continuation of International Application No. PCT/CN2025/100507, filed on Jun. 11, 2025, which claims priority to and benefits of Chinese Patent Applications Nos. 202521140619.2, 202521149427.8, 202510753101.4, 202521143965.6, 202521146766.0, 202521145632.7, 202510744796.X, 202510749515.X, 202510750969.9, 202510751139.8, and 202521145860.4, filed with China National Intellectual Property Administration on Jun. 5, 2025. The entire disclosures of all the above applications are incorporated herein by reference.

### FIELD

The present disclosure relates to the technical field of energy storage power supplies, and more particularly, to an energy storage power supply.

### BACKGROUND

As a large-capacity mobile power supply, an energy storage power supply is widely used in outdoor, industrial, and household energy storage scenarios. In the related art, a circuit board module and a battery module of the energy storage power supply require complex assembling and wiring within a shell of the energy storage power supply. However, the inventors have found that such an assembling mode leads to low efficiency.

### SUMMARY

In view of the above problems, the present disclosure provides an energy storage power supply, capable of improving assembling efficiency of the energy storage power supply.

In a first aspect, embodiments of the present disclosure provide an energy storage power supply. The energy storage power supply includes a shell, a circuit board module, and a battery module. The shell includes a first housing and a second housing detachably connected to the first housing. The first housing and the second housing define an accommodation chamber. The circuit board module includes an inverter circuit. The circuit board module is fixedly mounted at the first housing and is located in the accommodation chamber. The battery module is fixedly mounted at the second housing and is located in the accommodation chamber. The battery module is electrically connected to the circuit board module.

In the energy storage power supply according to the embodiments of the present disclosure, a modular design of the energy storage power supply is realized by designing the shell as the first housing and the second housing that are detachable, and fixing the circuit board module and the battery module at the respective housings. This design allows an assembling process in which pre-assembling of the circuit board module and the first housing as well as pre-assembling of the battery module and the second housing are independently completed, and then the circuit board module and the first housing as a whole as well as the battery module and the second housing as a whole are combined with each other. Thus, an overall assembling process is simplified, greatly reducing assembling complexity and significantly improving the assembling efficiency.

In a second aspect, there is provided an energy storage power supply. The energy storage power supply includes a first housing assembly and a second housing assembly. The first housing assembly includes a first housing and a circuit board module fixed at the first housing. The second housing assembly includes a second housing and a battery module fixedly mounted at the second housing. The first housing and the second housing are detachably connected to each other and define an accommodation chamber. Each of the circuit board module and the battery module is located in the accommodation chamber.

In the energy storage power supply according to the embodiments of the present disclosure, the modular design of the first housing assembly and the second housing assembly allows the circuit board module and battery module to be assembled separately before overall mounting. In this way, the overall assembling process is simplified, thereby improving the assembling efficiency.

The above description is only an overview of the technical solutions of the present disclosure. In order to have a clearer understanding of the technical means of the present disclosure, the technical solutions can be implemented in accordance with the contents of the specification. Moreover, in order to make the above and other purposes, features and advantages of the present disclosure more obvious and easier to understand, specific embodiments of the present disclosure are given below.

### BRIEF DESCRIPTION OF THE DRAWINGS

Various other advantages and benefits will become apparent to those skilled in the art after reading the detailed description of preferred embodiments given below. The accompanying drawings are used for a purpose of illustrating the preferred embodiments only, rather than limiting the present disclosure. Moreover, throughout the accompanying drawings, same elements are denoted by same reference numerals.

FIG. 1 is a schematic structural view of an energy storage power supply according to an embodiment of the present disclosure.

FIG. 2 is a schematic structural view of a first housing assembly according to an embodiment of the present disclosure.

FIG. 3 is a schematic structural view of a second housing assembly according to an embodiment of the present disclosure.

FIG. 4 is a schematic exploded view of an energy storage power supply according to an embodiment of the present disclosure.

FIG. 5 is a schematic view of an assembling process of a first housing assembly according to an embodiment of the present disclosure.

FIG. 6 is a schematic view of an assembling process of a second housing assembly according to an embodiment of the present disclosure.

FIG. 7 is a schematic view of an assembling process of an energy storage power supply according to an embodiment of the present disclosure.

FIG. 8 is a schematic structural view of a first housing according to an embodiment of the present disclosure.

FIG. 9 is a schematic structural view of a circuit board module according to an embodiment of the present disclosure.

FIG. 10 is a schematic view of a positional relationship between a circuit board module and a shielding member according to an embodiment of the present disclosure.

FIG. 10a is a schematic diagram of a connection relationship between a functional circuit and a battery module according to an embodiment of the present disclosure.

FIG. 11 is a schematic view of an assembling structure of a circuit board module and a second housing according to an embodiment of the present disclosure.

FIG. 12 is a schematic structural view of a second housing according to an embodiment of the present disclosure.

FIG. 12a is a schematic structural view of a battery cell according to an embodiment of the present disclosure.

FIG. 13 is a schematic view of an assembling structure of a second housing and a battery module according to an embodiment of the present disclosure.

FIG. 14 is a cross-sectional view taken along direction A-A of the assembling structure of FIG. 13.

FIG. 14a is a schematic partial structural view of a second housing and a battery module according to some embodiments of the present disclosure.

FIG. 15 is a partial enlarged view of part a of the assembling structure of FIG. 14.

FIG. 15a is a schematic exploded view of a battery module according to an embodiment of the present disclosure.

FIG. 16 is a schematic partial structural view of an energy storage power supply according to an embodiment of the present disclosure.

FIG. 17 is a schematic exploded view of an energy storage power supply according to another embodiment of the present disclosure.

FIG. 18 is a schematic exploded view of a circuit board module according to an embodiment of the present disclosure.

FIG. 19 is a schematic view of a positional relationship between a battery module and a thermal insulation member according to an embodiment of the present disclosure.

FIG. 19a is a schematic view of a positional relationship between a battery module and a circuit board module according to an embodiment of the present disclosure.

FIG. 20 is a schematic exploded view of an energy storage power supply according to yet another embodiment of the present disclosure.

FIG. 21 is a schematic structural view of an energy storage power supply according to another embodiment of the present disclosure.

FIG. 22 is a schematic structural view of a support mesh according to an embodiment of the present disclosure.

FIG. 23 is a schematic exploded view of a support mesh and a first housing according to an embodiment of the present disclosure.

FIG. 24 is a schematic view of an assembling structure of a support mesh and a first housing according to an embodiment of the present disclosure.

FIG. 25 is a schematic exploded view of an energy storage power supply according to still yet another embodiment of the present disclosure.

FIG. 26 is a schematic partial structural view of an energy storage power supply according to another embodiment of the present disclosure.

FIG. 27 is an enlarged view of part b of the energy storage power supply of FIG. 26.

FIG. 28 is a cross-sectional view of an energy storage power supply according to an embodiment of the present disclosure.

FIG. 29 is an enlarged view of part c of the energy storage power supply of FIG. 28.

FIG. 30 is a schematic structural view of a rotatable shaft according to an embodiment of the present disclosure.

FIG. 31 is a schematic structural view of a handle according to an embodiment of the present disclosure.

FIG. 32 is an enlarged view of part d of the handle of FIG. 31.

FIG. 33 is a schematic partial structural view of an energy storage power supply according to yet another embodiment of the present disclosure.

FIG. 34 is a schematic partial exploded view of the energy storage power supply of FIG. 33.

FIG. 35 is an enlarged view of part e of the energy storage power supply of FIG. 33.

FIG. 36 is a schematic view of an assembling structure of an elastic abutment member and a circuit board module according to an embodiment of the present disclosure.

FIG. 37 is an enlarged view of part f of the assembling structure of FIG. 36.

FIG. 38 is a schematic view of an assembling process of a support and a battery cell according to an embodiment of the present disclosure.

FIG. 39 is a schematic flowchart of an assembling method according to an embodiment of the present disclosure.

FIG. 40 is a schematic partial structural view of a battery module according to an embodiment of the present disclosure.

FIG. 41 is a schematic view of an assembling process of an electrical connector, a battery cell, and a support according to an embodiment of the present disclosure.

FIG. 42 is a schematic flowchart of an assembling method according to another embodiment of the present disclosure.

FIG. 43 is a schematic view of an assembling process of a battery module according to an embodiment of the present disclosure.

FIG. 44 is a schematic flowchart of an assembling method according to yet another embodiment of the present disclosure.

FIG. 45 is a schematic flowchart of an assembling method according to still yet another embodiment of the present disclosure.

FIG. 46 is a schematic flowchart of an assembling method according to still yet another embodiment of the present disclosure.

### DESCRIPTION OF REFERENCE NUMERALS

energy storage power supply 100; shell 10; circuit board module 20; battery module 30; first housing 11; second housing 12; accommodation chamber 13; ventilation portion 110a; ventilation opening 110; air inlet 1100; air outlet 1101; first base plate 111; facing plate 112; opening 112a; first circuit board 21; second circuit board 22; direct-current conversion circuit 22b; insertion hole 210; insertion protrusion 220; insertion slot 120; female header 21a; pin header 22a; output port 102a; USB port 101; in-vehicle charging port 102; support 31; battery cell 32; mounting groove 121; second base plate 122; second side plate 123; support rib plate 1221; first limit groove 1222; first end 320; second end 321; pressure relief structure 32a; support structure 121a; pressure relief groove 121b; notch 121c; guide channel 121d; support portion 121e; connection portion 121f; first electrode 3200; second electrode 3201; electrical connector 33; functional element 20b; first high region 34; first low region 35; second high region 23; second low region 24; first heat-generation element 230; second heat-generation element 240; plate body 211; cooling fan 212; air duct element 213; thermal insulation member 40; shielding member 25; support mesh 50; limit strip 113; second limit groove 114; mesh portion 51; mounting portion 52; mesh hole 51a; stud 115; first side plate 116; first stud 1150; second stud 1151; handle assembly 60; open slot 14; handle 61; rotatable shaft 62; fixing member 63; snap ring 630; catching opening 631; adapter hole 15; damping member 64; pivot hole 610; stop groove 620; stop protrusion 611; enclosure wall 1110; weight reduction groove 621; slide button 80; elastic abutment member 90; assembling hole 16; body 91; elastic arm 92; hollow hole 910; trough portion 920; support table 17; protruding block 93; through hole 911; mounting post 18; pressing block 94; first housing assembly 103; second housing assembly 104; fixing groove 310; first positioning structure 330; second positioning structure 312; collection assembly 105; functional circuit 214; battery management circuit 2140; inverter circuit 2141; solar charging circuit 2142.

### DETAILED DESCRIPTION OF THE EMBODIMENTS

Embodiments of technical solutions of the present disclosure will be described in detail below with reference to the accompanying drawings. The following embodiments are only used to more clearly illustrate the technical solutions of the present disclosure, and therefore are only used as examples, and cannot be used to limit the protection scope of the present disclosure.

Unless otherwise defined, all technical and scientific terms used herein have the same meaning as commonly understood by those skilled in the art of the present disclosure. Terms in the specification of the present disclosure herein are only used for the purpose of describing exemplary embodiments, and are not intended to limit the present disclosure. Terms “including” and “having” and any variants thereof as used in the description of the embodiments of the present disclosure, the appended claims, and the above accompanying drawings are intended to cover non-exclusive inclusions.

In the description of the present disclosure, terms such as “first” and “second” are used herein for purposes of description and are not intended to indicate or imply relative importance, or to implicitly show the number of technical features, specific orders, or primary and secondary relationships indicated. In the description of the present disclosure, “a plurality of” means two or more, unless otherwise specifically defined.

Reference herein to “an embodiment” means that a particular feature, structure or characteristic described in combination with the embodiment can be included in at least one embodiment of the present disclosure. The appearance of this phrase in various places in the specification is not necessarily all referring to the same embodiment, nor is it an independent or alternative embodiment that is mutually exclusive of other embodiments. Those skilled in the art understand, both explicitly and implicitly, that the embodiments described herein may be combined with other embodiments.

In the description of the present disclosure, “and/or” describes an association relationship between correlated objects, including three relationships. For example, “A and/or B” can mean A only, B only, or both A and B. In addition, the symbol “/” generally indicates an “or” relationship between the correlated objects preceding and succeeding the symbol.

In the description of the present disclosure, the term “a plurality of” refers to more than two (including two). Similarly, “a plurality of groups” refers to more than two groups (including two groups), and “a plurality of pieces” refers to more than two pieces (including two pieces).

In the description of the present disclosure, it is to be understood that, terms such as “center,” “longitudinal,” “lateral,” “length,” “width,” “thickness,” “over,” “below,” “front,” “back,” “left,” “right,” “vertical,” “horizontal,” “top,” “bottom,” “in,” “out,” “clockwise,” “counterclockwise,” “axial,” “radial,” “circumferential,” etc., are based on the orientation or position relationship shown in the accompany drawings, and are only for the convenience of describing the present disclosure and simplifying the description, rather than indicating or implying that the associated device or element must have a specific orientation, or be constructed and operated in a specific orientation, and therefore cannot be understood as a limitation on the present disclosure.

In the description of the present disclosure, unless specified or limited otherwise, the terms “mounted,” “connected,” “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components. For those of ordinary skill in the art, the specific meaning of the above-mentioned terms in the present disclosure can be understood according to specific circumstances.

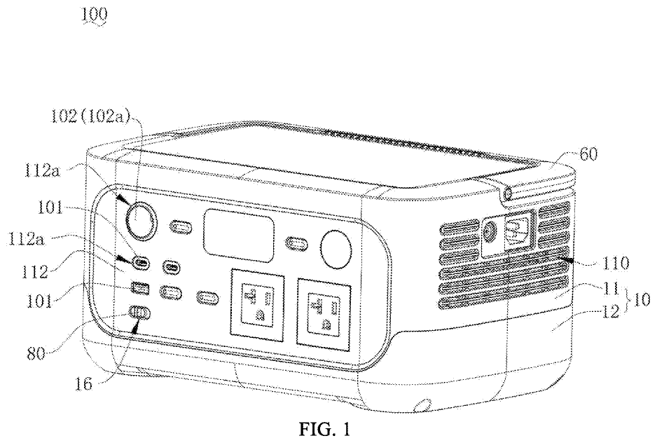

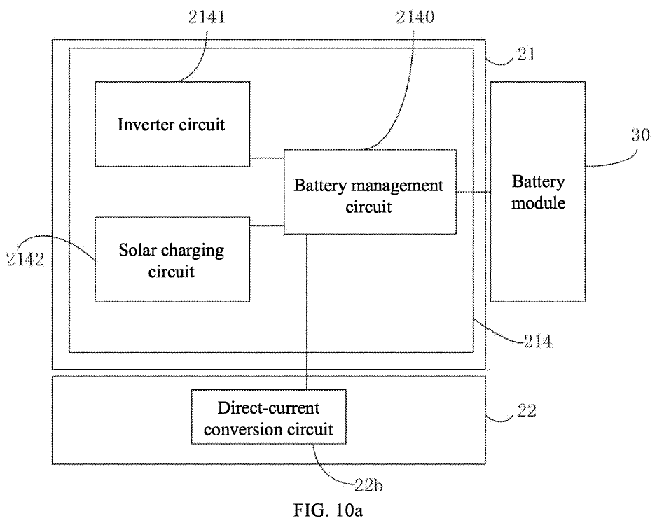

Referring to FIGS. 1, 2, 3, and 4, according to embodiments of the present disclosure, an energy storage power supply 100 includes a shell 10, a circuit board module 20, and a battery module 30. The shell 10 includes a first housing 11 and a second housing 12 detachably connected to the first housing 11. The first housing 11 and the second housing 12 define an accommodation chamber 13. The circuit board module 20 includes an inverter circuit 2141 (as shown in FIG. 10a). The circuit board module 20 is fixedly mounted at the first housing 11 and is located in the accommodation chamber 13. The battery module 30 is fixedly mounted at the second housing 12 and is located in the accommodation chamber 13. The battery module 30 and the circuit board module 20 are electrically connected to each other.

In the energy storage power supply 100 according to the embodiments of the present disclosure, a modular design of the energy storage power supply 100 is realized by designing the shell 10 as the first housing 11 and the second housing 12 that are detachable, and fixing the circuit board module 20 and the battery module 30 at the respective housings. This design allows an assembling process in which pre-assembling of the circuit board module 20 and the first housing 11 as well as pre-assembling of the battery module 30 and the second housing 12 are independently completed, and then the circuit board module 20 and the first housing 11 as a whole as well as the battery module 30 and the second housing 12 as a whole are combined with each other. Thus, an overall assembling process is simplified, greatly reducing assembling complexity and significantly improving assembling efficiency.

In an exemplary embodiment of the present disclosure, the shell 10 is an external protective structure of the energy storage power supply 100 and is configured to accommodate and protect internal assemblies. The battery module 30 and the circuit board module 20 are accommodated in the shell 10. The shell 10 may be made of metal, plastic, or other composite materials.

The detachable connection between the first housing 11 and the second housing 12 may be a bolt connection, a snap-fit connection, an insertion connection, or the like. The accommodation chamber 13 is an internal space defined by the first housing 11 and the second housing 12. The accommodation space is configured to accommodate the circuit board module 20 and the battery module 30 to provide a protected internal environment.

The circuit board module 20 is a control and management core of the energy storage power supply 100 and includes various electronic components and control circuits. The circuit board module 20 may be configured for conversion, control, and management of electrical energy to ensure normal operation of the energy storage power supply 100. The circuit board module 20 may be fixedly mounted at the first housing 11 through a bolt connection, a snap-fit connection, an insertion connection, or the like.

The inverter circuit 2141 is a circuit that converts a direct current into an alternating current. The inverter circuit 2141 can realize conversion between the alternating current and the direct current, and therefore the energy storage power supply 100 can adapt to different power demands, in which the energy storage power supply 100 can convert a direct current of the battery module 30 into an alternating current for external output, and also can convert an external alternating current input into a direct current to supply power to the battery module 30.

The battery module 30 is an energy storage unit of the energy storage power supply 100 and may include a plurality of battery cells 32. The battery module 30 is configured to store electrical energy to provide energy support for output of the energy storage power supply 100. The battery module 30 may adopt a lithium-ion battery, a lead-acid battery or batteries of other types, which are specifically selected depending on energy storage requirements and application scenarios. The battery module 30 may be fixedly mounted at the second housing 12 through a bolt connection, a snap-fit connection, an insertion connection, or the like.

The electrical connection means that an electrical path is established between the circuit board module 20 and the battery module 30 through an electrical component such as a wire and a connector, and therefore electrical energy and a signal can be transmitted between the circuit board module 20 and the battery module 30. Through the electrical connection, the circuit board module 20 can control and manage the battery module 30 to ensure stable transmission of the electrical energy. The circuit board module 20 and the battery module 30 may be electrically connected to each other through welding, a bolt connection, a terminal connection, a wire connection, or the like.

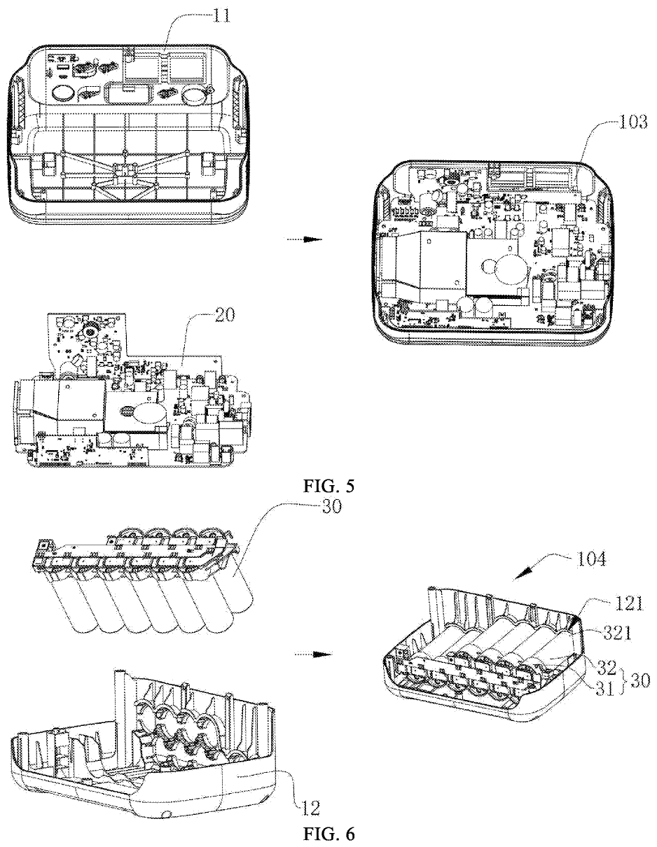

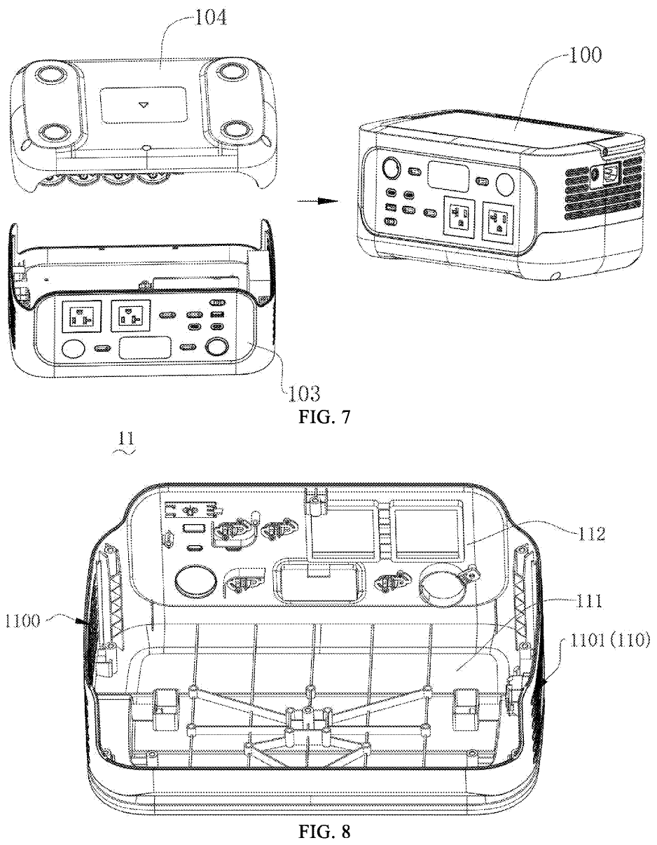

Referring to FIGS. 5, 6, and 7, during assembling, first, the circuit board module 20 may be fixedly mounted at the first housing 11, and the battery module 30 may be fixedly mounted at the second housing 12. Then, the first housing 11 and the second housing 12 may be detachably connected to each other to be assembled into a complete shell 10, to form the accommodation chamber 13. Finally, the circuit board module 20 and the battery module 30 may be connected to each other through an electrical connection, thereby completing assembling of the energy storage power supply 100.

The battery module 30 is configured to, when in use, store electrical energy and transmit the electrical energy to the circuit board module 20 through an electrical connection. The circuit board module 20 is configured to, when in use, convert, control, and manage the electrical energy to ensure stable output of the electrical energy.

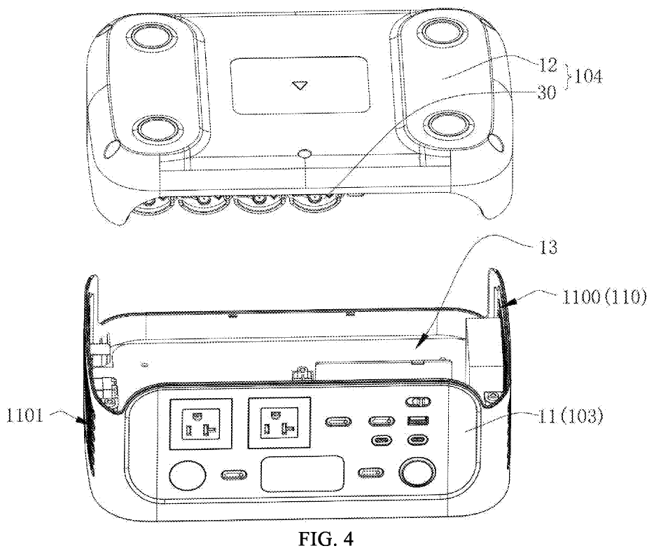

Referring to FIGS. 1 and 4, in some embodiments, the first housing 11 has a ventilation opening 110 in communication with the accommodation chamber 13.

In this way, by providing the ventilation opening 110 at the first housing 11, air circulation can be promoted, a temperature in the accommodation chamber 13 can be effectively reduced. Thus, heat dissipation performance of the energy storage power supply 100 can be improved. Therefore, operational stability of the energy storage power supply 100 can be enhanced, prolonging a service life of the internal assemblies of the energy storage power supply 100.

In an exemplary embodiment of the present disclosure, the ventilation opening 110 is an opening formed at the first housing 11 for promoting air circulation. The ventilation opening 110 may be designed in a louver type, grid type, or other forms to prevent foreign objects from entering an interior of the device. One or more ventilation openings 110 may be provided. For example, two ventilation openings 110 may be provided and spaced apart from each other at the first housing 11. The ventilation opening 110 may be of a regular shape, such as a circular shape and a square shape, or may be of an irregular shape.

Referring to FIG. 4, in some embodiments, the ventilation opening 110 includes an air inlet 1100 and an air outlet 1101. The air inlet 1100 and the air outlet 1101 are located at two opposite sides of the first housing 11.

In this way, the air inlet 1100 and the air outlet 1101 are located at the two opposite sides of the first housing 11. This design forms a long air flow path, allowing air to flow through most regions inside the energy storage power supply 100, thereby significantly improving heat dissipation efficiency.

In an exemplary embodiment of the present disclosure, the two opposite sides may be a front side and a rear side, a left side and a right side, or an upper side and a lower side of the energy storage power supply 100. For example, for the energy storage power supply 100 of a rectangular-parallelepiped shape, the air inlet 1100 and the air outlet 1101 may be disposed at the left side and the right side of the energy storage power supply 100, or may be spaced apart from each other in a length direction of the energy storage power supply 100.

Referring to FIGS. 1, 2, and 8, in some embodiments, the first housing 11 includes a first base plate 111 and a facing plate 112 connected to the first base plate 111. The facing plate 112 is connected to the second housing 12, and at least part of the circuit board module 20 is fixedly mounted at the first base plate 111.

In this way, by designing the first housing 11 as a combined structure of the first base plate 111 and the facing plate 112, the circuit board module 20 can be pre-mounted at the first base plate 111, and then the facing plate 112 and the second housing 12 are assembled into a complete housing. Such a step-by-step assembling mode can simplify the assembling process, reduce the assembling complexity, and improve the assembling efficiency.

In an exemplary embodiment of the present disclosure, the first base plate 111 is a part of the first housing 11 and may be of a flat plate-like structure. The first base plate 111 may be of a regular shape such as a rectangular shape or a circular shape, or may be of an irregular shape. For example, the first base plate 111 is of a rectangular shape. The first base plate 111 may be directly connected to the facing plate 112, or may be spaced apart from the facing plate 112 and indirectly connected to the facing plate 112 through other structures. The first base plate 111 may have a mounting hole, an insertion slot, and other structures for fixing and mounting of the circuit board module 20. The circuit board module 20 may be fixedly mounted at the first base plate 111 through a bolt connection, a snap-fit connection, or an insertion connection.

The facing plate 112 is another part of the first housing 11 and may be a flat plate-like structure. The facing plate 112 may be of a regular shape such as a rectangular shape and a circular shape, or may be of an irregular shape. For example, the facing plate 112 is of a rectangular shape. The facing plate 112 may be connected to the second housing 12 through a bolt connection, a snap-fit connection, an insertion connection, or the like.

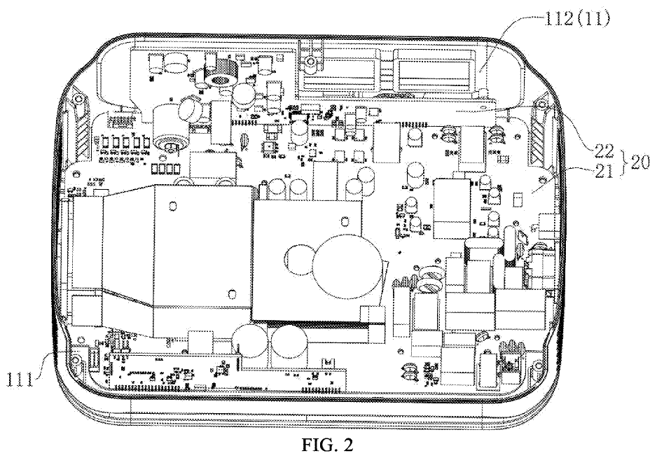

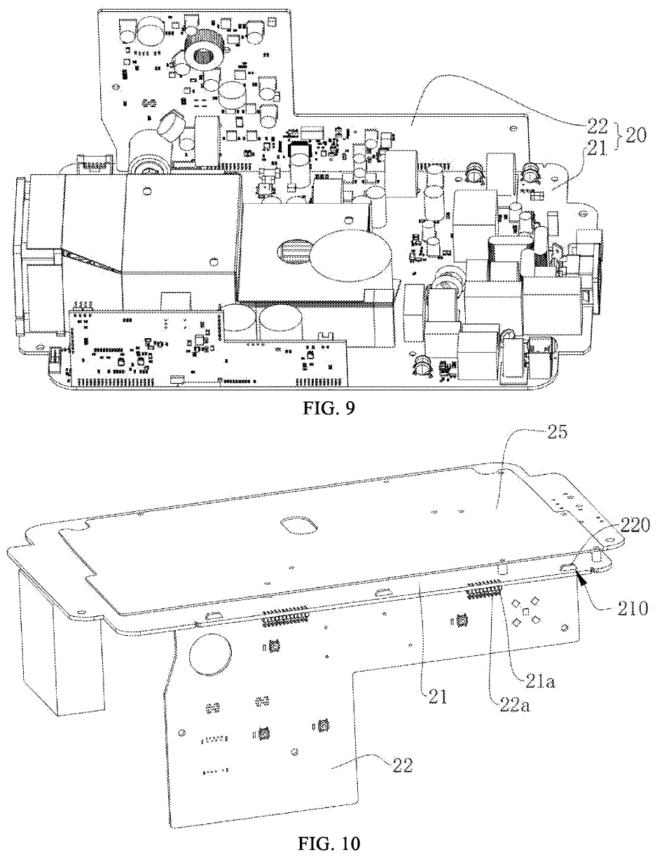

Referring to FIGS. 2 and 9, in some embodiments, the circuit board module 20 includes a first circuit board 21 and a second circuit board 22 electrically connected to the first circuit board 21. The first circuit board 21 is fixedly mounted at the first base plate 111, and the second circuit board 22 is fixed at the facing plate 112.

In this way, by dividing the circuit board module 20 into the first circuit board 21 and the second circuit board 22 and fixedly mounting the first circuit board 21 and the second circuit board 22 at the first base plate 111 and the facing plate 112, distributed mounting of the circuit board can be realized. Such a distributed mounting mode allows different parts of the circuit board to be handled separately during the assembling process, thereby simplifying assembling steps and improving the assembling efficiency.

In an exemplary embodiment of the present disclosure, the first circuit board 21 and the second circuit board 22 are two different parts of the circuit board module 20. The first circuit board 21 and the second circuit board 22 may be connected to each other according to a predetermined angle. For example, an angle between the first circuit board 21 and the second circuit board 22 may be 45 degrees, 60 degrees, 90 degrees, or other angles.

The electrical connection between the first circuit board 21 and the second circuit board 22 can be realized through welding, a bolt connection, a terminal connection, a wire connection, or the like.

In some embodiments, the first circuit board 21 is fixed at the first base plate 111 by a screw.

In some embodiments, the second circuit board 22 is fixed at the facing plate 112 by a screw.

In some embodiments, the first circuit board 21 is fixed at the first base plate 111 by a screw, and the second circuit board 22 is fixed at the facing plate 112 by a screw.

In this way, the screw fixation provides a firm mechanical connection to ensure that the circuit board remains stable under a complex environment such as vibration and impact and thus to prevent an electrical failure caused by a loose connection. Moreover, the screw fixing is a common fastening mode with readily available tools, simple operation, and ease of mounting and maintenance. When the circuit board needs to be replaced or repaired, disassembling can be completed by simply loosening the screw, improving maintenance efficiency.

In an exemplary embodiment of the present disclosure, one or more screws may be provided, for example, two, three, four, or even more screws may be provided. A plurality of screws can provide a plurality of connection points, thereby increasing connection strength. The screw fixation can be combined with a washer, a spring washer, and other accessories to enhance a fixing effect.

Referring to FIGS. 1 and 9, in some embodiments, the facing plate 112 has an opening 112a. The first circuit board 21 and the second circuit board 22 are disposed at a predetermined angle. The first circuit board 21 includes an inverter circuit 2141. The second circuit board 22 includes an output port 102a. The output port 102a directly faces towards the open 112a.

In this way, the output port 102a directly faces towards the opening 112a of the facing plate 112, facilitating an external connection directly through the opening 112a by a user without an additional adapter device or complex wiring, which enhances user experience.

In an exemplary embodiment of the present disclosure, the angle between the first circuit board 21 and the second circuit board 22 may be 30 degrees, 60 degrees, 90 degrees, or 120 degrees, etc.

The opening 112a may be an opening opened at the facing plate 112. One or more openings 112a may be provided. The number of openings 112a may be in one-to-one correspondence with the output ports 102a.

The output port 102a may be a USB port 101 or an in-vehicle charging port 102.

Referring to FIGS. 2 and 9, in some embodiments, the first circuit board 21 is arranged horizontally, and the second circuit board 22 is arranged vertically.

In this way, by disposing the first circuit board 21 horizontally and the second circuit board 22 vertically, a three-dimensional space inside the energy storage power supply 100 can be utilized more effectively, avoiding overlapping and interference between the circuit boards, and improving space utilization. In addition, the horizontal and vertical layout makes the mounting and maintenance of the circuit board more convenient. Maintenance personnel can more easily access and operate different circuit boards without disassembling other assemblies, improving maintenance efficiency.

In an exemplary embodiment of the present disclosure, the horizontal arrangement means that the first circuit board 21 is mounted in a horizontal direction. Through the horizontal arrangement, the first circuit board 21 can more effectively utilize a horizontal space, avoiding interference with other assemblies.

The vertical arrangement means that the second circuit board 22 is mounted in a vertical direction. Through the vertical arrangement, the second circuit board 22 can more effectively utilize a vertical space, optimizing an overall layout.

Referring to FIG. 2, in some embodiments, each of the first circuit board 21 and the second circuit board 22 is fixed at the first housing 11.

In this way, the first circuit board 21 and the second circuit board 22 are fixed at the first housing 11. Such a fixing mode facilitates maintaining a reasonable layout between the circuit boards, avoiding the overlapping and interference between the circuit boards, and further improving a utilization rate of an internal space of the energy storage power supply 100.

If the first housing 11 and the second housing 12 are not detachable, the second housing 12 would interfere with the mounting of the first circuit board 21 and the second circuit board 22. Therefore, by providing the first housing 11 and the second housing 12 that are detachably connected to each other, the first circuit board 21 and the second circuit board 22 can be pre-fixed at the first housing 11, and then the second housing 12 is connected to the first housing 11, thereby completing the assembling of the entire energy storage power supply 100. Such a modular design improves production efficiency and reduces assembling time.

In an exemplary embodiment of the present disclosure, each of the first circuit board 21 and the second circuit board 22 may be fixed at the first housing 11 through a bolt connection, a snap-fit connection, an insertion connection, or the like.

Referring to FIG. 10, in some embodiments, one of the first circuit board 21 and the second circuit board 22 has an insertion hole 210, and the other one of the first circuit board 21 and the second circuit board 22 is provided with an insertion protrusion 220. The insertion protrusion 220 is inserted into the insertion hole 210 to enable the first circuit board 21 to be fixedly connected to the second circuit board 22.

In this way, the design of the insertion hole 210 and the insertion protrusion 220 allows for a quick connection and disassembling between the circuit boards without tools, significantly improving the assembling efficiency and the maintenance efficiency.

In an exemplary embodiment of the present disclosure, the insertion hole 210 is an opening or a recess formed at the circuit board for accommodating the insertion protrusion 220. The insertion hole 210 may be designed in different shapes (such as a circular shape, a square shape, and a rectangular shape) and sizes to adapt to different insertion protrusions 220. The insertion protrusion 220 is a protruding part provided at the circuit board for insertion into the insertion hole 210. A plurality of insertion holes 210 and a plurality of insertion protrusions 220 may be provided.

Referring to FIG. 10, in an example, the first circuit board 21 has an insertion hole 210, and the second circuit board 22 is provided with an insertion protrusion 220. In another example, the first circuit board 21 is provided with an insertion protrusion 220, and the second circuit board 22 has an insertion hole 210. The insertion protrusion 220 is fixed in the insertion hole 210 through soldering. The first circuit board 21 is further provided with a female header 21a, and the second circuit board 22 is further provided with a pin header 22a. The electrical connection between the first circuit board 21 and the second circuit board 22 is realized by inserting the pin header 22a into the female header 21a. During mounting, the connection is completed only by inserting the pin header 22a into a slot of the female header 21a, without additional tools or devices, which is convenient and fast.

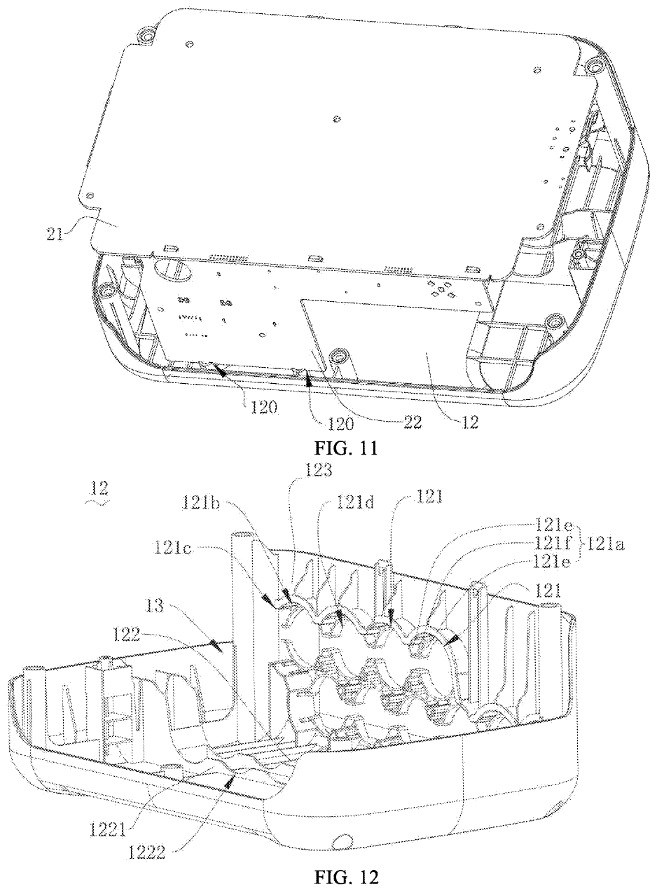

Referring to FIG. 11, in some embodiments, the second housing 12 has an insertion slot 120, and an edge of the second circuit board 22 away from the first circuit board 21 is inserted into the insertion slot 120.

In this way, such an insertion mode simplifies mounting and disassembling processes of the second circuit board 22, making a position of the second circuit board 22 stable, without additional fixing tools or complicated connection steps, significantly improving the assembling efficiency.

In an exemplary embodiment of the present disclosure, the insertion slot 120 is a recess formed at the second housing 12 for accommodating the edge of the second circuit board 22. A width of the insertion slot 120 may be slightly greater than a width of the edge of the second circuit board 22 to facilitate the insertion of the second circuit board 22. A length of the insertion slot 120 may be longer than a length of the second circuit board 22 to reserve a predetermined space, which can compensate for a manufacturing tolerance of the second circuit board 22.

The insertion slot 120 may be formed at an inner surface of the second housing 12, or may be formed in other manners. For example, the second housing 12 is provided with two upright posts at an inner surface of the second housing 12, and the two upright posts have insertion slots 120 aligned with each other.

Referring to FIG. 10a, in some embodiments, the first circuit board 21 includes a functional circuit 214. The functional circuit 214 includes a battery management circuit 2140, an inverter circuit 2141, and a solar charging circuit 2142. The battery management circuit 2140 is electrically connected to the battery module 30 and is configured to connect or disconnect an electrical connection between the battery module 30 and an external circuit. The inverter circuit 2141 is electrically connected to the battery module 30 via the battery management circuit 2140 and is configured to convert between an alternating current and a direct current. The solar charging circuit 2142 is electrically connected to the battery module 30 via the battery management circuit 2140 and is configured to maximize electrical energy generated by a solar panel. In this way, the battery management circuit 2140, the inverter circuit 2141, and the solar charging circuit 2142 are integrated at the first circuit board 21, thereby realizing a multi-functional integrated design. Such an integrated design reduces the number of assemblies, simplifies a circuit layout, improves compactness and reliability of the device, and improves the assembling efficiency.

The battery management circuit 2140 is configured to monitor a state of the battery module 30 in real time, including a parameter such as a voltage, a current, and a temperature, to ensure that a battery operates within a safe range. This helps prolong a service life of the battery and improve reliability and safety of the battery. The solar charging circuit 2142 is designed to maximize the electrical energy generated by the solar panel. By optimizing a charging process, utilization efficiency of solar energy is improved, making the energy storage power supply 100 more efficient in solar power supply scenarios.

In an exemplary embodiment of the present disclosure, the battery management circuit 2140 is a circuit for monitoring and managing the battery module 30. The battery management circuit 2140 is configured to monitor a voltage, a current, and a temperature of the battery module 30 to ensure that the battery module 30 operates within a safe range, and control a charging and discharging process of the battery module 30 to extend a service life of the battery module 30. The battery management circuit 2140 can provide functions including overcharge protection, over-discharge protection, short-circuit protection, etc.

The solar charging circuit 2142 is a circuit for converting the electrical energy generated by the solar panel into electrical energy suitable for storage by the battery module 30. The solar charging circuit 2142 may be connected to the solar panel. The solar panel is configured to convert solar energy into electrical energy. A solar charging circuit is configured to convert the electrical energy of the solar panel into electrical energy storable by the energy storage power supply 100.

In some embodiments, the second circuit board 22 includes an output circuit, a display screen, and a button. The output circuit is configured to be electrically connected to an external circuit and output power. The display screen is configured to display information such as input power, output power, and an electric quantity of the energy storage power supply 100. The button may be configured to control an operating state of the energy storage power supply 100.

In this way, the output circuit allows the energy storage power supply 100 to be directly connected to the external circuit, and therefore the user can conveniently use the energy storage power supply 100 to power various devices without an additional adapter device or complicated connection steps. As a result, convenience of use is improved.

In an exemplary embodiment of the present disclosure, the output circuit refers to a circuit for transmitting electrical energy from the energy storage power supply 100 to an external device. The output circuit may include a variety of interfaces, such as a USB interface, a direct-current output interface, and an alternating-current output interface, to adapt to different device requirements.

The electrical connection to the external circuit refers to an electrical connection between the energy storage power supply 100 and the external device. The electrical connection of the external circuit may be in a wired or wireless form. The wired connection includes a USB cable, a power supply adapter cable, etc.

The output power of the output circuit may be adjusted according to specific needs, such as supporting 5 V/2 A USB output, or 12 V/10 A direct-current output. It should be noted that the numerical values herein are only examples for ease of understanding and shall not be construed as a limitation of the embodiments of the present disclosure.

Referring to FIG. 10a, in some embodiments, the second circuit board 22 includes a direct-current conversion circuit 22b. The direct-current conversion circuit 22b is electrically connected to the battery module 30 via the battery management circuit 2140 and is configured to convert the electrical energy of the battery module 30 into a direct current and output the direct current externally through the output port 102a.

In this way, the electrical energy subjected to the direct-current conversion can supply power to various direct-current devices, such as a mobile device and a lighting device, through the output port 102a, which enhances versatility and practicality of the energy storage power supply 100 and makes it applicable to a variety of application scenarios.

Referring to FIG. 1, in some embodiments, the output circuit includes at least one of a USB port 101 and an in-vehicle charging port 102. In one embodiment, the USB port 101 is exposed through the facing plate 112. In one embodiment, the in-vehicle charging port 102 is exposed through the facing plate 112. In one embodiment, the USB port 101 and the in-vehicle charging port 102 are exposed through the facing plate 112.

In this way, by integrating the USB port 101 and the in-vehicle charging port 102, dependence on external adapters or connector adapters is reduced, and the user's usage cost is lowered.

In an exemplary embodiment of the present disclosure, the USB port 101 is a universal serial bus interface for connecting various USB devices. The USB port 101 can provide a standardized interface to facilitate the user to connect and charge the various USB devices, such as a mobile phone, a tablet, and a laptop. The USB port 101 can support a plurality of standards, such as USB-A, USB-C, and USB-B. Common output power specifications include 5 V/2 A, 9 V/2 A, 12 V/1.5 A, etc. The USB port 101 can be designed to support fast charging protocols, such as QC3.0 and PD.

The in-vehicle charging port 102 is a charging interface specially designed for an in-vehicle device, which may be an in-vehicle charging interface. The in-vehicle charging port 102 can provide a charging interface for an in-vehicle device, making it convenient for the user to charge the device in an in-vehicle environment. The in-vehicle charging port 102 can support 12 V, 24 V, and other outputs, and may be designed to support a variety of in-vehicle devices, such as a mobile phone, a tablet, and a car navigation system.

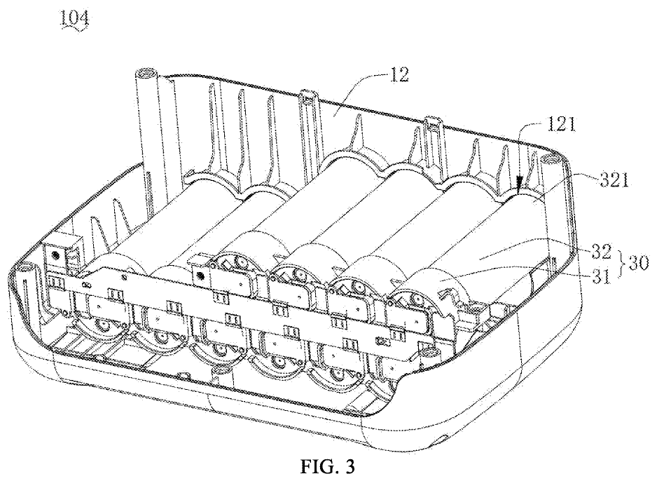

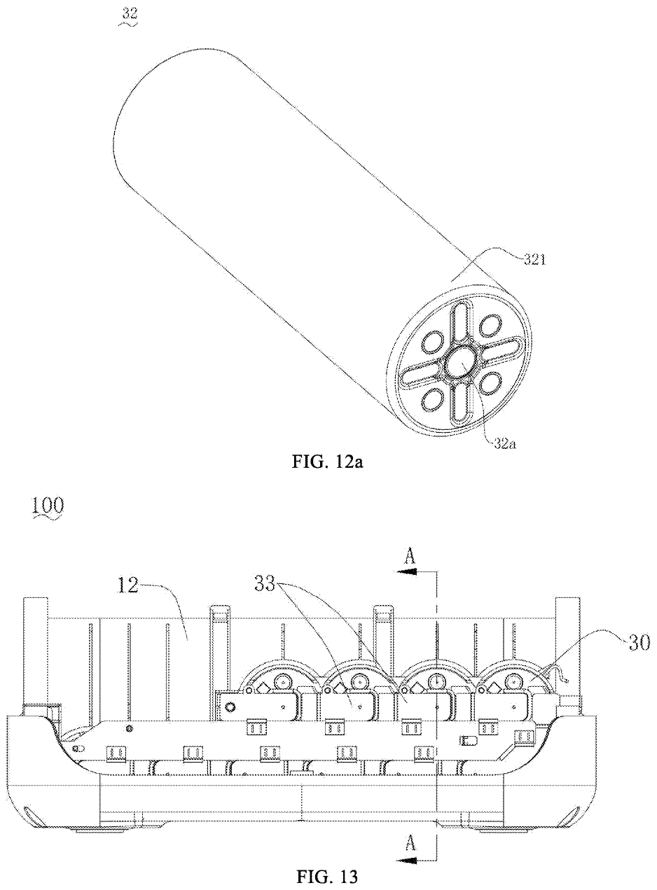

Referring to FIGS. 3 and 12, in some embodiments, the battery module 30 includes a support 31 and a plurality of battery cells 32, and each of the plurality of battery cells 32 is mounted at the support 31 at an end of the battery cell 32. The second housing 12 has a plurality of mounting grooves 121. The battery cell 32 is embedded into a corresponding mounting groove 121 of the plurality of mounting grooves 121 at the other end of the battery cell 32. The support 31 is fixedly mounted at the second housing 12 to fix the plurality of battery cells 32 to the second housing 12.

In this way, the design of the support 31 allows an assembling process in which the ends of the plurality of battery cells 32 are pre-mounted at the support 31, and then the entire battery module 30 is embedded into the mounting grooves 121 to fix the entire battery module 30 at the second housing 12, which simplifies the assembling steps and improves the assembling efficiency.

The mounting process of the battery cell 32 is simplified by the mounting groove 121, and the fixing is completed only by embedding the end of the battery cell 32 into the mounting groove 121, without additional fixing tools or complicated connection steps, which significantly improves the assembling efficiency. Moreover, through the design of the mounting groove 121, the end of the battery cell 32 can be firmly embedded into the second housing 12, avoiding displacement or loosening of the battery cell 32 under vibration or impact, thereby improving mounting stability of the battery module 30.

In an exemplary embodiment of the present disclosure, the support 31 is a structural component for fixing and supporting the battery cell 32. The support 31 can provide stable mechanical support to ensure that the battery cell 32 is free from the displacement or the loosening during operation.

The support 31 may be fixedly mounted at the second housing 12 through a bolt connection, a snap-fit connection, an insertion connection, or the like. The support 31 and the second housing 12 may also be of an integrally formed structure, which can reduce connection gaps and weak points when the support 31 is connected to the second housing 12, thereby enhancing overall rigidity of the support 31 and the second housing 12.

The plurality of mounting grooves 121 may be in one-to-one correspondence with the plurality of battery cells 32. The mounting groove 121 may be formed by an inner wall of the second housing 12 and a rib structure provided on the inner wall of the second housing 12. The mounting groove 121 is configured to fix the battery cell 32. A groove wall of the mounting groove 121 may be larger than a diameter of the battery cell 32. An inner wall of the mounting groove 121 may have a shape similar to a shape of an outer surface of the battery cell 32. Two, three, four, or even more mounting grooves 121 may be provided.

Referring to FIG. 12, in some embodiments, the second housing 12 includes a second base plate 122 and a second side plate 123 connected to the second base plate 122. The plurality of mounting grooves 121 are formed in the second side plate 123, and the second side plate 123 is connected to the first housing 11.

In this way, the mounting groove 121 in the second side plate 123 can optimize a layout of the battery cell 32, making a connection between the battery cell 32 and the housing more compact. As a result, unnecessary space occupation is reduced, and a space utilization rate is improved.

In addition, by designing the second housing 12 as the combined structure of the second base plate 122 and the second side plate 123, the battery cell 32 can be mounted in a step-by-step manner. Such a step-by-step mounting manner allows different assemblies to be handled separately during the assembling process, thereby simplifying the assembling steps and improving the assembling efficiency.

In an exemplary embodiment of the present disclosure, the second base plate 122 is a part of the second housing 12 and is generally of a flat plate-like structure. The second base plate 122 may be of a regular shape such as a rectangular shape or a circular shape, or may be of an irregular shape. For example, the second base plate 122 is of a rectangular shape.

The second side plate 123 is another part of the second housing 12 and may be of a plate-like structure perpendicular to the second base plate 122. The second side plate 123 is configured to be connected to the first housing 11 and constitutes a part of the accommodation chamber 13. The second side plate 123 may be connected to the first housing 11 through a bolt connection, a snap-fit connection, an insertion connection, or the like.

Referring to FIG. 12, in some embodiments, the second base plate 122 is provided with a support rib plate 1221. The support rib plate 1221 has a first limit groove 1222, and the battery cell 32 abuts with a groove wall of the first limit groove 1222.

In this way, the support rib plate 1221 can not only provide a heat dissipation function, but also provide pre-positioning for the battery cell 32, thereby facilitating the mounting of the battery cell 32.

In an exemplary embodiment of the present disclosure, one or more support rib plates 1221 may be provided. For example, two support rib plates 1221 may be provided. The two support rib plates 1221 are disposed in parallel at a surface of the second base plate 122 facing towards the battery cell 32. Each of the two support rib plates 1221 has a plurality of first limit grooves 1222. Each of the plurality of first limit grooves 1222 is configured to limit a corresponding battery cell 32. In this way, the battery cell 32 can be stably fixed in the first limit groove 1222, thereby preventing the battery cell 32 from shaking during use.

A shape of the first limit groove 1222 may match a shape of an outer circumferential surface of the battery cell 32. For example, the battery cell 32 may be of a cylindrical shape, and the first limit groove 1222 may be of an arc shape.

Referring to FIGS. 12, 12a, 13, 14, and 14a, in some embodiments, the battery cell 32 has a first end 320 and a second end 321 in a length direction of the battery cell 32. A pressure relief structure 32a is formed at the second end of the battery cell 32. The battery cell 32 is embedded into the corresponding mounting groove 121 at the second end 321 of the battery cell 32. Each of the plurality of mounting grooves 121 is internally provided with a support structure 121a. The support structure 121a abuts with the second end 321 of the battery cell 32 in such a manner that a predetermined gap is formed between the second end 321 and a bottom of the mounting groove 121 to form a pressure relief groove 121b in communication with the accommodation chamber 13.

In this way, when the battery cell 32 undergoes thermal runaway, generated high-pressure gas may be discharged in time through the pressure relief groove 121b, avoiding an explosion caused by gas accumulation inside the battery module 30, thereby significantly improving safety performance of the energy storage power supply 100 under the thermal runaway condition. Moreover, the pressure relief structures 32a of the plurality of battery cells 32 may be in communication with each other via the pressure relief groove 121b. As a result, the pressure relief structure 32a of any battery cell 32 in the battery module 30 can achieve the purpose of pressure relief during the thermal runaway.

In an exemplary embodiment of the present disclosure, the pressure relief structure 32a may be an explosion-proof valve or a score line provided at the second end 321 of the battery cell 32. For example, the pressure relief structure 32a may be an explosion-proof valve. The explosion-proof valve internally has a weak position or is internally provided with a weak device. When a pressure of the battery cell 32 increases, the weak position is opened by the pressure, thereby releasing the high-pressure gas of the battery cell 32 to prevent explosion or combustion of the battery cell 32 caused by abnormal conditions such as overcharging, overdischarging, and a short circuit. For another example, the pressure relief structure 32a may be a mechanically processed score line formed at the second end 321 of the battery cell 32, and the above-mentioned weak position is formed at the score line.

The support structure 121a may be a protrusion protruding from an inner wall of the accommodation chamber 13. For example, the support structure 121a may be a rib protruding from the inner wall of the accommodation chamber 13. Thus, the support structure 121a can support the battery cell 32, and an end of the battery cell 32 can be spaced apart from the inner wall of the accommodation chamber 13. Thus, the pressure relief groove 121b can be formed between the battery cell 32 and the inner wall of the accommodation chamber 13.

Referring to FIG. 12, in some embodiments, the mounting groove 121 has a notch 121c at a side wall of the mounting groove 121, and the pressure relief groove 121b is in communication with the accommodation chamber 13 via the notch 121c.

In this way, the communication between the pressure relief groove 121b and the accommodation chamber 13 is realized by providing the notch 121c at the side wall of the mounting groove 121. Such a design is relatively simple and is easily implemented during production. Compared to a complex internal air guide channel or other pressure relief structures 32a, the notch 121c is less difficult to process, which can reduce complexity of a manufacturing process, lower production costs, and improve production efficiency. Moreover, pressure relief and heat dissipation performance can be optimized by adjusting a size, shape, and position of the notch 121c to adapt to different operating environments and safety standards.

In an exemplary embodiment of the present disclosure, one or more notches 121c may be provided. For example, two, three, four, or even more notches 121c may be provided. A plurality of notches 121c may be symmetrically opened on the side wall of the mounting groove 121, which can improve a pressure relief effect.

Referring to FIG. 12, in some embodiments, the plurality of mounting grooves 121 are arranged side by side. Two adjacent mounting grooves 121 of the plurality of mounting grooves 121 are in communication with each other via the notch 121c. A notch 121c at a side wall of one of the two adjacent mounting grooves 121 of the plurality of mounting grooves 121 is in communication with the accommodation chamber 13.

In this way, by forming the notch 121c at the side wall of the mounting groove 121 to bring the pressure relief groove 121b into communication with the accommodation chamber 13, the high-pressure gas ejected from the battery cell 32 can be guided out of the pressure relief groove 121b to achieve the purpose of the pressure relief.

Moreover, the plurality of mounting grooves 121 are arranged side by side, the two adjacent mounting grooves 121 are in communication with each other via the notch 121c, and the notch 121c at the side wall of one of the two adjacent mounting grooves 121 is in communication with the accommodation chamber 13. Such a design forms a continuous pressure relief channel. When thermal runaway occurs in any battery cell 32, the generated high-pressure gas can not only be discharged into the accommodation chamber 13 through the notch 121c of its own pressure relief groove 121b, but can also be diffused and discharged to the entire pressure relief channel through the notch 121c of the adjacent mounting groove 121.

In an exemplary embodiment of the present disclosure, a size of the notch 121c bringing the two adjacent mounting grooves 121 into communication with each other and a size of the notch 121c in communication with the accommodation chamber 13 may be the same or different. The notch 121c may be formed through mechanical processing or injection molding. The shape of the notch 121c may be set arbitrarily according to requirements, which is not limited by the embodiments of the present disclosure.

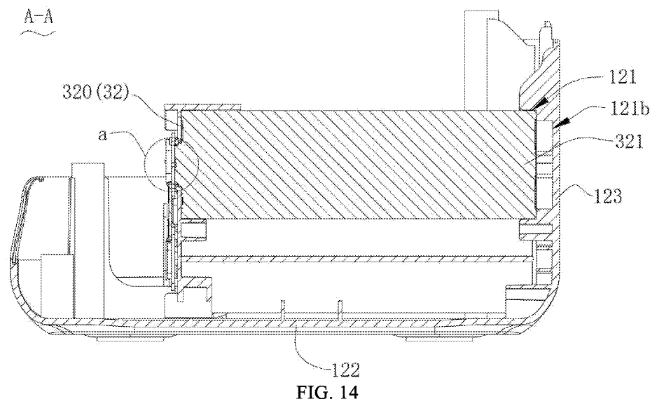

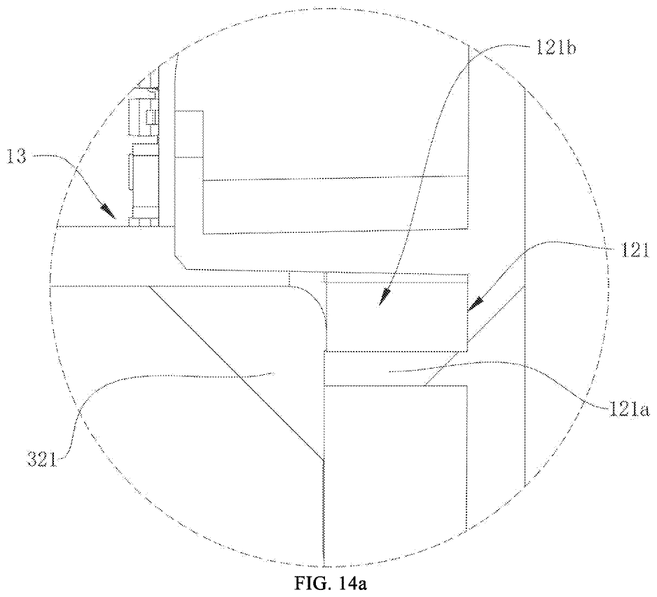

Referring to FIGS. 12 and 14, in some embodiments, a gap is formed between the side wall of the mounting groove 121 and a side wall of the battery cell 32, and the pressure relief groove 121b is in communication with the accommodation chamber 13 via the gap.

In this way, by forming the gap between the side wall of the mounting groove 121 and the side wall of the battery cell 32, the high-pressure gas ejected from the battery cell 32 can flow into the accommodation chamber 13 from the gap to achieve the purpose of the pressure relief.

Moreover, the gap between the side wall of the mounting groove 121 and the side wall of the battery cell 32 is used to realize the communication between the pressure relief groove 121b and the accommodation chamber 13. Such a design does not require additional processing of complex pressure relief channels or communication structures, reducing the complexity of the manufacturing process, lowering the production costs, and improving the production efficiency.

In an exemplary embodiment of the present disclosure, the battery cell 32 has a diameter that can be adapted to a diameter of the mounting groove 121, and therefore the gap is formed by the side wall of the mounting groove 121 and the side wall of the battery cell 32, and the pressure relief groove 121b is in communication with the accommodation chamber 13 via the gap. Thus, the high-pressure gas released by the battery cell 32 into the pressure relief groove 121b can flow into the accommodation chamber 13 from the gap.

Referring to FIG. 12, in some embodiments, the support structure 121a is of an arc shape, and the battery cell 32 is a cylindrical battery; and the support structure 121a abuts with an edge of the second end 321 of the battery cell 32.

In this way, the shape of the support structure 121a matches the shape of the battery cell 32, and therefore the support structure 121a can effectively support the battery cell 32 and prevent the battery cell 32 from shaking.

Referring to FIG. 12, in some embodiments, the support structure 121a is a protruding rib provided in the mounting groove 121, and the protruding rib is connected to the side wall of the mounting groove 121.

In this way, by providing the protruding rib, a predetermined gap is formed between the second end 321 of the battery cell 32 and a bottom of the mounting groove 121, thereby ensuring the formation of the pressure relief groove 121b and the communication between the pressure relief groove 121b and the accommodation chamber 13. Moreover, the protruding rib can effectively distribute a pressure applied to the second end 321 of the battery cell 32, avoiding shaking and displacement of the battery cell 32 in the mounting groove 121, thereby improving overall structural stability of the battery module 30.

In an exemplary embodiment of the present disclosure, the protruding rib may be in various forms, such as a linear protruding rib and an arc-shaped protruding rib. For example, the protruding rib may be of an arc shape, and the arc-shaped protruding rib may fit against the side wall of the battery cell 32 and is adjacent to the mounting groove 121. Since the protruding rib directly abuts with the second end 321 of the battery cell 32, if the second end 321 is subjected to a relatively high pressure and thus collapses, a short circuit may occur to the battery cell 32. However, since the protruding rib of the arc shape is adjacent to the mounting groove 121 and abuts with the edge of the second end 321 of the battery cell 32, most pressure is transmitted to the side wall of the battery cell 32 rather than the end of the battery cell 32, which can greatly reduce a risk of the short circuit of the battery cell 32.

The protruding rib and the side wall of the mounting groove 121 may be of an integrally formed structure, which can reduce the connection gaps and the weak points. Thus, structural rigidity of the protruding rib can be improved. Thus, support performance of the protruding rib can be improved. The protruding rib may have a continuous structure, which can be easily manufactured and thus lower the manufacturing costs.

Referring to FIGS. 12 and 14, in some embodiments, two protruding ribs are provided and opposite to each other, and the pressure relief groove 121b is formed by the two protruding ribs.

In this way, the two protruding ribs are opposite to each other to form the pressure relief groove 121b. Such a design can realize effective support and pressure relief functions for the battery cell 32 without occupying an additional space. The two protruding ribs can uniformly distribute the pressure applied to the second end 321 of the battery cell 32, preventing the battery cell 32 from tilting or shaking in the mounting groove 121, further improving the overall structural stability of the battery module 30. The two protruding ribs can better protect the battery cell 32 and reduce a risk of damage to the battery cell 32 especially during vibration or drop impact of the energy storage power supply 100.

In an exemplary embodiment of the present disclosure, the two protruding ribs may have a symmetrical structure, which can provide more uniform support for the battery cell 32.

Referring to FIGS. 12 and 14, in some embodiments, the battery cell 32 is a cylindrical battery, and each of the two ribs includes a support portion 121e and a connection portion 121f. The support portion 121e is of an arc shape and is disposed in the mounting groove 121. The connection portion 121f extends through the two mounting grooves 121 and is connected to two support portions 121e at two ends of the connection portion 121f. The two ribs extend through the plurality of mounting grooves 121 to form a guide channel 121d. The guide channel 121d is in communication with the accommodation chamber 13, and the pressure relief structure 32a faces towards the guide channel 121d.

In this way, when any battery cell 32 undergoes thermal runaway, the guide channel 121d can guide the high-pressure gas and quickly discharge the high-pressure gas, thereby reducing accumulation and spread of the high-pressure gas in the battery module 30. Such a design helps inhibit spread of the thermal runaway among the plurality of battery cells 32, protect other battery cells 32 from the thermal runaway, and further improve safety of the energy storage power supply 100. The arc-shaped support portion 121e can stably support the cylindrical battery and prevent the cylindrical battery from shaking. The connection portion 121f extends through the two mounting grooves 121 and is connected to the two supporting portions 121e at the two ends of the connection portion 121f. Such a design can enhance the stability of the battery cell 32 in a single mounting groove 121. Furthermore, by connecting the adjacent support portions 121e together by the connection portion 121f, the structural stability of the entire battery module 30 can be improved.

In an exemplary embodiment of the present disclosure, inner wall surfaces of the two protruding ribs may be formed into the guide channel 121d. The guide channel 121d may have an opening. The opening may be in communication with the accommodation chamber 13. A bottom wall of the second end 321 of the battery cell 32 may be located in the guide channel 121d. The pressure relief structure 32a may be disposed at the bottom wall of the second end 321 of the battery cell 32. When the battery cell 32 undergoes the thermal runaway, the high-pressure gas released by the pressure relief structure 32a can enter the guide channel 121d and be discharged to the accommodation chamber 13 under guidance of the guide channel 121d.

The connection portion 121f and the support portion 121e may be of an integrally formed structure, which can reduce the connection gaps and the weak points, thereby enhancing overall structural rigidity of the connection portion 121f and the support portion 121e.

Referring to FIGS. 8, 12, and 16, in some embodiments, the first base plate 111 and the second base plate 122 are opposite to each other, and the facing plate 112 and the second side plate 123 are opposite to each other.

In this way, the layout of the first base plate 111, the second base plate 122, the facing plate 112, and the second side plate 123 makes the first housing 11 and the second housing 12 easy to mount, thereby improving the assembling efficiency.

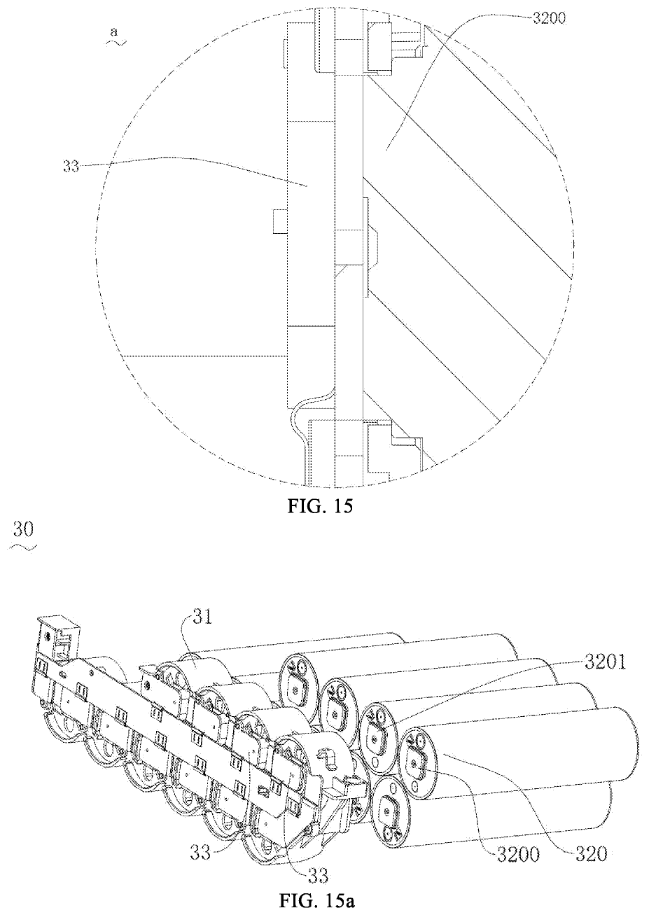

Referring to FIGS. 13, 14, 15, and FIG. 15a, in some embodiments, the battery cell 32 is provided with a first electrode 3200 and a second electrode 3201 at the first end 320 of the battery cell 32. The battery module 30 includes an electrical connector 33. The electrical connector 33 is configured to connect the first electrode 3200 of one of two adjacent battery cells 32 of the plurality of battery cells 32 and the second electrode 3201 of the other one of the two adjacent battery cells 32 to enable the two adjacent battery cells 32 to be connected to each other. The second end 321 of the battery cell 32 is embedded into the corresponding mounting groove 121.

In this way, through the cooperation of the first electrode 3200, the second electrode 3201, and the electrical connector 33, an electrical connection between the plurality of battery cells 32 can be quickly realized. Further, the plurality of battery cells 32 can be assembled as a whole, which simplifies the assembling process and improves the assembling efficiency. By embedding the second end 321 of the battery cell 32 into the corresponding mounting groove 121, and in combination with the fixing of the first electrode 3200, the second electrode 3201, and the electrical connector 33, stability of the battery cell 32 in a vibration or impact environment is ensured, and the risk of the displacement or the loosening is reduced.

In an exemplary embodiment of the present disclosure, the battery cell 32 serves as a basic unit of the battery module 30 for storing and supplying electrical energy. The plurality of battery cells 32 may be combined in series or in parallel to form the battery module 30 to provide a required voltage and capacity. The battery cell 32 may be of various types, such as a lithium-ion battery, a lead-acid battery, or a nickel-metal hydride battery. The battery cell 32 may be designed in different shapes and sizes, such as a cylindrical shape, a square shape, or a pouch type.

The first electrode 3200 may be a positive electrode, and the second electrode 3201 may be a negative electrode. A lithium-ion battery is taken as an example for illustration. A positive electrode plate may include a positive electrode current collector and a positive electrode active material layer. The positive electrode current collector may be made of aluminum. The positive electrode active material layer may include a positive electrode active material, such as lithium cobalt oxide, lithium iron phosphate, ternary lithium, or lithium manganate oxide. A negative electrode plate may include a negative electrode current collector and a negative electrode active material layer. The negative electrode current collector may be made of copper. The negative electrode active material layer may include a negative electrode active material, such as carbon or silicon.

The electrical connector 33 is an electrical connection component configured to connect adjacent battery cells 32. The electrical connector 33 cooperates with the electrodes of different battery cells 32 and can thus realize the electrical connection between the adjacent battery cells 32, thereby ensuring stable current transmission. The electrical connector 33 may be in many forms, such as a connection sheet, a connection wire, and a welding point. The electrical connector 33 may be made of metal with excellent conductivity, such as copper and aluminum. The electrical connector 33 may be designed to have a protective function, such as an insulation layer and an anti-loosening structure.

Referring to FIGS. 17, 18, 19, and 19a, in some embodiments, the battery module 30 and the circuit board module 20 are spaced apart from each other in a first direction v of the accommodation chamber 13. The battery module 30 has a first high region 34 and a first low region 35 that have a height difference in the first direction v. The circuit board module 20 has a second high region 23 and a second low region 24 that have a height difference in the first direction v. The first high region 34 and the second low region 24 partially overlap in the first direction v, and the first low region 35 and the second high region 23 partially overlap in the first direction v. The first high region 34 and the second high region 23 partially overlap in a second direction h. The second direction h is perpendicular to the first direction v.

In this way, the first low region 35 of the battery module 30 can provide an avoidance space for the second high region 23 of the circuit board module 20, and the second low region 24 of the circuit board module 20 can provide an avoidance space for the first high region 34 of the battery module 30. By setting the height difference in the first direction v, the battery module 30 and the circuit board module 20 partially overlap in the second direction h. Such an offset layout makes the structure of the battery module 30 compact, significantly improving a space utilization rate of the accommodation chamber 13, and reducing an overall volume. As a result, portability of the energy storage power supply 100 is improved.

In an exemplary embodiment of the present disclosure, for the energy storage power supply 100 of a cuboid shape, the first direction v may be a height direction of the energy storage power supply 100, and the second direction h may be a length direction of the energy storage power supply 100.

The height difference refers to different height regions of the battery module 30 or the circuit board module 20 in the first direction v. The overlap means that projection regions of the battery module 30 and the circuit board module 20 in the first direction v or the second direction h cover each other.

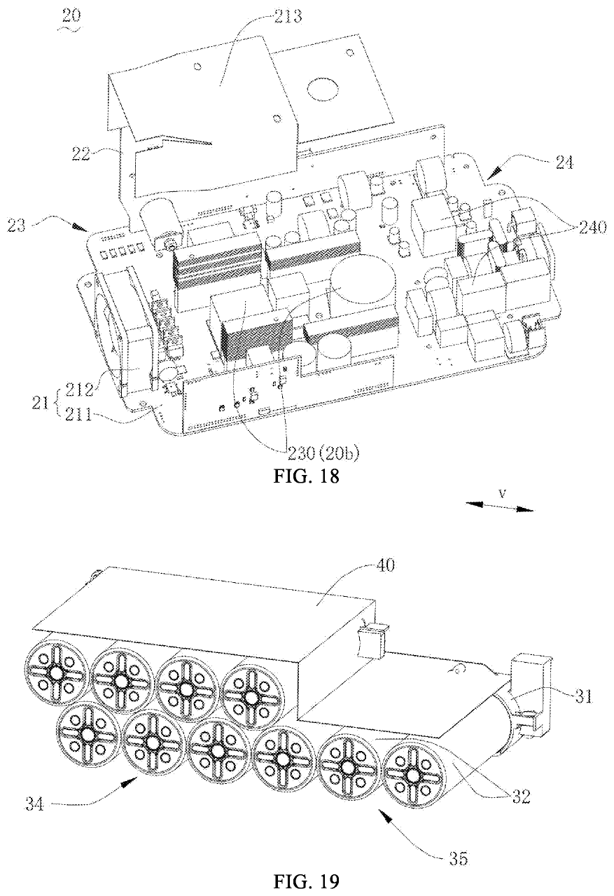

Referring to FIGS. 17 and 18, in some embodiments, the first circuit board 21 has a second high region 23 and a second low region 24.

In this way, by dividing the circuit board module 20 into the first circuit board 21 and the second circuit board 22, and configuring the second high region 23 and the second low region 24 on the first circuit board 21, a space of the accommodation chamber 13 can be utilized more flexibly. The height difference design of the first circuit board 21 can provide more avoidance space for the second circuit board 22 or other assemblies, thereby further optimizing the overall layout and improving the space utilization rate.

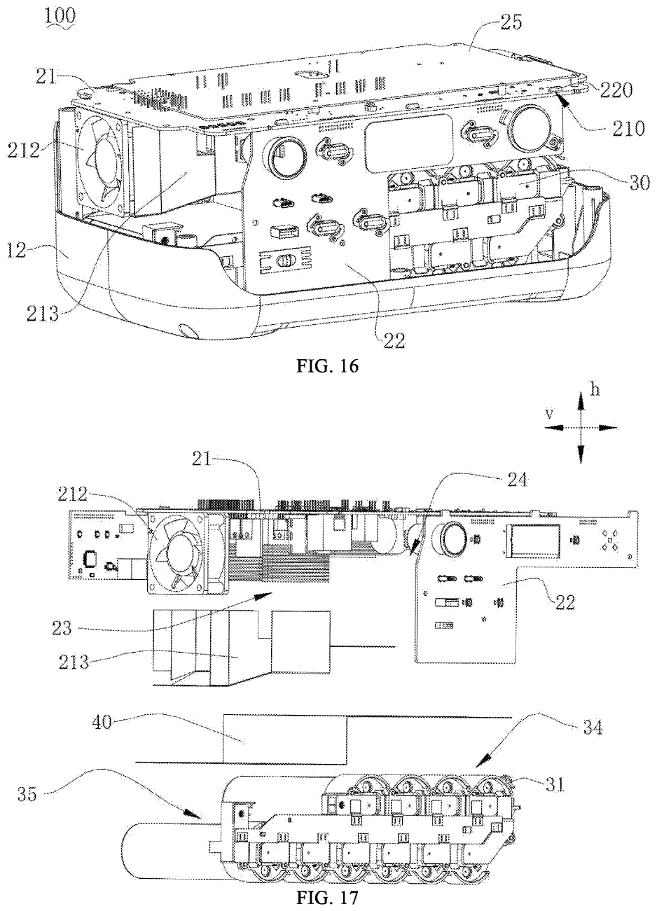

Referring to FIGS. 16 and 18, in some embodiments, the first housing 11 and the second housing 12 are arranged in a height direction of the energy storage power supply 100. The first housing 11 is disposed at a top of the second housing 12. The circuit board module 20 includes a plate body 211 and a functional element 20b disposed at the plate body 211. The plate body 211 is disposed at a top of the first housing 11. The functional element 20b is disposed at the plate body 211 and faces towards the battery module 30.

In this way, such a layout can shorten an electrical connection distance between the functional element 20b of the circuit board module 20 and the battery module 30, which shortens a length of a connection wire and reduces complexity of the connection wire, thus reducing signal transmission loss and electromagnetic interference.

In an exemplary embodiment of the present disclosure, the functional element 20b may include a sensor, a controller, a communication module, etc. The functional element 20b can realize various functions of the circuit board module 20, such as monitoring a state of a battery and controlling charging and discharging processes. The functional element 20b may include a variety of electrical elements having different heights and functions. For example, the functional element 20b may include a first heat-generation element 230 and a second heat-generation element 240.

Referring to FIGS. 16 and 18, in some embodiments, the plate body 211 is fixed to the shell 10, and the functional element 20b is oriented towards the battery module 30 in the first direction v, to form the second high region 23 and the second low region 24 on the circuit board module 20. In this way, by optimizing the layout of the functional element 20b, the circuit board module 20 can have the second high region 23 and the second low region 24, which can be staggered with the first high region 34 and the first low region 35 of the battery module 30 to improve the space utilization rate of the accommodation chamber 13.

Referring to FIG. 18, in some embodiments, the first heat-generation element 230 is disposed in the second high region 23, and the second heat-generation element 240 is disposed in the second low region 24. Heat generated by the first heat-generation element 230 is greater than heat generated by the second heat-generation element 240.

In this way, by arranging the first heat-generation element 230 that generates a larger amount of heat in the second high region 23, a relatively open space of the second high region 23 can be utilized, or an additional heat dissipation structure can be designed to improve heat dissipation efficiency. Moreover, when the second heat-generation element 240 that generates a smaller amount of heat is arranged in the second low region 24, performance of the second heat-generation element 240 cannot be affected by poor heat dissipation even if a space of the second low region 24 is relatively compact.

In an exemplary embodiment of the present disclosure, the first heat-generation element 230 may be an element of the circuit board that generates a larger amount of heat, such as a Metal-Oxide-Semiconductor Field-Effect Transistor (MOSFET), an inductor, a transformer, and a heat dissipation fin. The second heat-generation element 240 may be an element of the circuit board that generates a smaller amount of heat, such as a connector and a capacitor.

In other embodiments, an element having a higher height is placed in the second high region 23, and an element having a lower height is placed in the second low region 24.

Referring to FIGS. 16, 17, and 18, in some embodiments, the first circuit board 21 includes a plate body 211 and a cooling fan 212 disposed at the plate body 211. The cooling fan 212 is disposed at an end of the second high region 23 away from the second low region 24 and constitutes at least part of the second high region 23. An airflow that flows through the second low region 24 for heat dissipation is formed by the cooling fan 212.

In this way, the position of the cooling fan 212 allows the cooling fan 212 to dissipate heat for both the second high region 23 and the second low region 24 simultaneously, and has a better heat dissipation effect on the second high region 23, which can effectively reduce a temperature of the first heat-generation element 230 that generates a larger amount of heat. Such an active heat dissipation design can significantly improve the heat dissipation efficiency of the energy storage power supply 100 and ensure that the first heat-generation element 230 operates within a safe temperature range, especially under a high-load operating condition.

In addition, since the cooling fan 212 constitutes the at least part of the second high region 23, a fan with a relatively high airflow can be selected as the cooling fan 212, thereby providing a better heat dissipation effect.

In an exemplary embodiment of the present disclosure, the cooling fan 212 is an active heat dissipation device that generates an airflow through rotation to take away heat. The cooling fan 212 may be disposed at the plate body 211 through a bolt connection or other mechanical connections. The cooling fan 212 is configured for air blowing or air suction. The cooling fan 212, when configured for the air blowing, can generate a cooling airflow directed towards the second low region 24; and the cooling fan 212, when configured for the air suction, can form a cooling airflow directed towards the second high region 23.

Referring to FIGS. 16, 17, and 18, in some embodiments, the first circuit board 21 further includes an air duct element 213 disposed at the plate body 211. The air duct element 213 has an airflow channel extending from the cooling fan 212 to the second high region 23. The air duct element 213 constitutes a part of the second low region 24.

In this way, the airflow channel formed by the air duct element 213 can guide the airflow generated by the cooling fan 212 to flow more directly towards the heat-generation element in the second high region 23, thereby improving the heat dissipation efficiency. Such a directional heat dissipation design can ensure that the first heat-generation element 230 disposed in the second high region 23 is cooled more effectively, especially under the high-load operating condition.

In an exemplary embodiment of the present disclosure, the air duct element 213 is a structural component for guiding an airflow. The air duct element 213 has an inlet adjacent to the second high region 23 and an outlet adjacent to an air inlet 1100 of the cooling fan 212. In this way, under the air suction action of the cooling fan 212, the airflow enters an interior of the air duct element 213 through the second low region 24, flows through the second high region 23, and is discharged by the cooling fan 212. Heat generated in the second low region 24 is relatively low, and the airflow will not be excessively heated after flowing through the second low region 24. When the airflow flows to the second high region 23, the temperature of the airflow is relatively low, which is more conducive to taking away heat from the second high region 23. The air duct element 213 may be made of plastic or a metal material. The air duct element 213 may be an air guide hood, an air guide pipe, or other similar structures. For example, the air duct element 213 may be an air guide pipe made of a plastic material. The air guide pipe has an inlet adjacent to the air outlet 1101 of the cooling fan 212 and an outlet adjacent to the second high region 23.

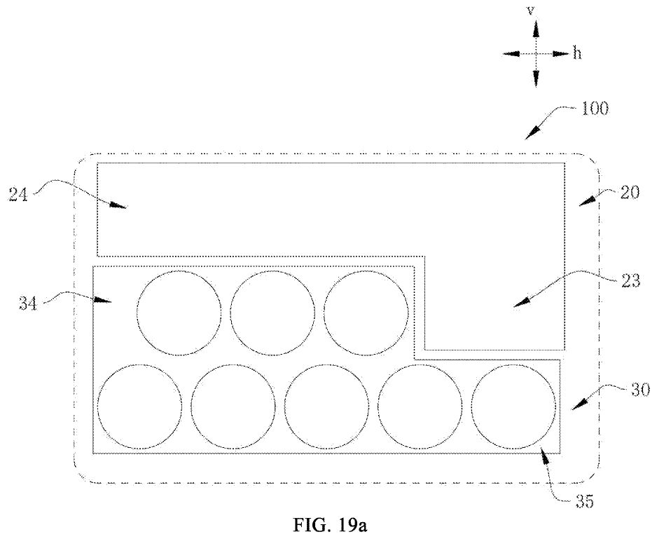

Referring to FIGS. 17 and 19, in some embodiments, the support 31 is fixedly mounted at the shell 10, and some of the plurality of battery cells 32 are stacked in the first direction v, to form the first high region 34 and the first low region 35 on the battery module 30.

In this way, by stacking some of the plurality of battery cells 32 in the first direction v, the first high region 34 and the first low region 35 that have a height difference can be formed, thereby providing an avoidance space for the circuit board module 20 or other assemblies. Such a design significantly improves the space utilization rate of the accommodation chamber 13 and makes the overall structure of the energy storage power supply 100 more compact.

In an exemplary embodiment of the present disclosure, the support 31 may be fixedly mounted at the shell 10 through a bolt connection, a snap-fit connection, an insertion connection, or the like. Two layers of battery cells 32 may be stacked in the first high region 34, and one layer of battery cells 32 may be stacked in the first low region 35. Thus, the battery cells 32 in different regions in the battery module 30 can have a height difference to form the first high region 34 and the first low region 35.

Referring to FIGS. 17, 19, and 20, in some embodiments, the energy storage power supply 100 includes a thermal insulation member 40 disposed between the battery module 30 and the circuit board module 20. The thermal insulation member 40 covers the battery module 30.

In this way, the thermal insulation member 40 can effectively isolate heat transfer between the battery module 30 and the circuit board module 20, and prevent heat generated by the battery module 30 from affecting normal operation of the circuit board module 20. As a result, thermal stability of the circuit board module 20 is improved, thereby avoiding performance degradation or service life reduction of the circuit board module 20 caused by overheating.

In an exemplary embodiment of the present disclosure, the thermal insulation member 40 is a component for reducing heat transfer and may be made of a low thermal conductivity material, such as ceramic fiber, asbestos, or aerogel. The thermal insulation member 40 may be designed in a plate shape, a sheet shape, or other suitable shapes.

Covering the battery module 30 means that the thermal insulation member 40 completely covers the battery module 30, or that an orthographic projection of the battery module 30 on the thermal insulation member 40 is located within the thermal insulation member 40.

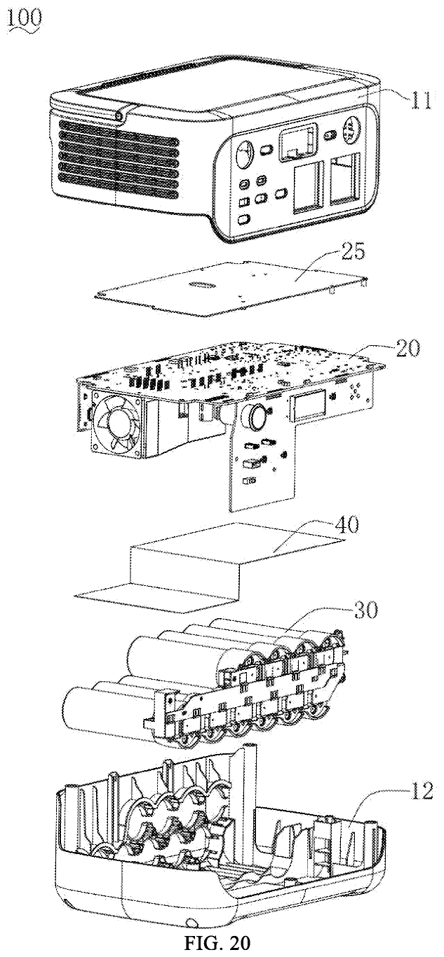

Referring to FIGS. 16 and 20, in some embodiments, the circuit board module 20 is provided with a shielding member 25 at a side of the circuit board module 20 away from the battery module 30. In one embodiment, the shielding member 25 is configured for heat dissipation. In one embodiment, the shielding member 25 is configured for electromagnetic interference shielding. In one embodiment, the shielding member 25 is configured for heat dissipation and electromagnetic interference shielding.

In this way, since the shielding member 25 is disposed at the side of the circuit board module 20 away from the battery module 30, the heat generated by the circuit board module 20 can be effectively guided and dissipated, avoiding heat accumulation, and improving the heat dissipation efficiency. Timely heat dissipation can reduce a failure risk of the circuit board module 20 caused by the overheating and improve reliability of the circuit board module 20 during a long-term operation or under a high-load condition. Moreover, by reducing electromagnetic interference, the shielding member 25 helps improve signal integrity and reliability of the circuit board module 20, ensuring accuracy and stability of data transmission.

In an exemplary embodiment of the present disclosure, the shielding member 25 is a component for heat dissipation, which may be made of a high thermal conductivity material, such as aluminum, copper, or graphite. The shielding member 25 may be in many forms, such as a heat sink, a heat pipe, a fan, and a thermal paste. The shielding member 25 may be in a passive heat dissipation mode or an active heat dissipation mode. The shielding member 25 can achieve the heat dissipation function in a variety of ways, such as increasing a surface area, using a thermally conductive material, and designing an air flowing channel.

The shielding member 25 may be made of an electromagnetic shielding material (such as a metallic plate or a conductive coating). The shielding member 25 can effectively shield electromagnetic interference generated by the circuit board module 20 to prevent its impact on other surrounding electronic devices. Meanwhile, the shielding member 25 can also prevent external electromagnetic interference from entering the circuit board module 20 to ensure normal operation of the circuit board module 20. When it is necessary to provide heat dissipation and electromagnetic interference shielding functions simultaneously, an aluminum plate, a copper plate, etc., may be adopted for the shielding member 25.

In some embodiments, the shielding member 25 abuts with the shell 10.

In this way, since the shielding member 25 abuts with the shell 10, the heat generated by the circuit board module 20 can be directly conducted to the shell 10, and then dissipated to an external environment through the shell 10. Such a design significantly improves the heat dissipation efficiency and ensures stable operation of the circuit board module 20 especially under a high-load operation condition.

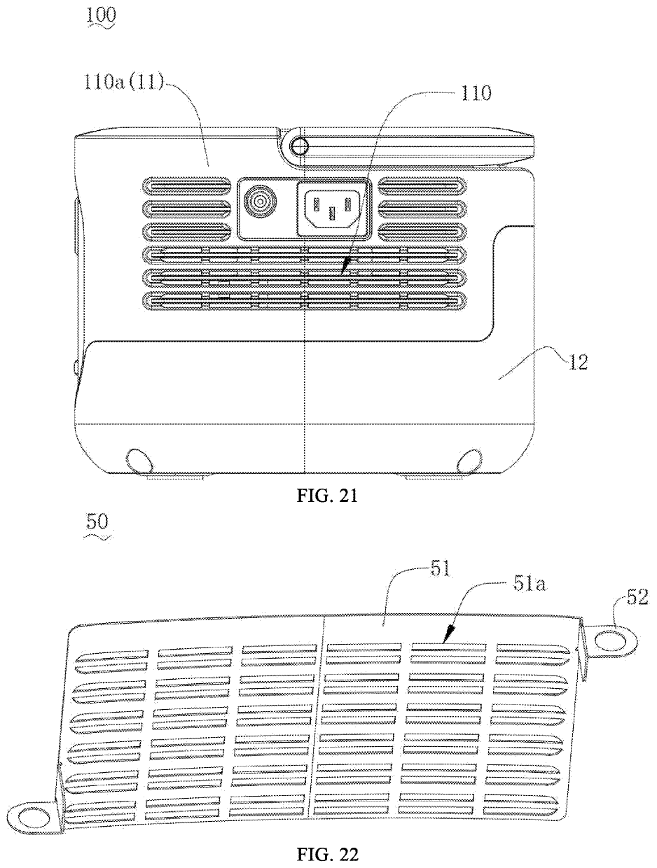

Referring to FIGS. 21, 22, 23, and 24, in some embodiments, the energy storage power supply 100 further includes a support mesh 50. The shell 10 is provided with a ventilation portion 110a having a ventilation opening 110. The battery module 30 is disposed in the shell 10. The support mesh 50 is disposed at an inner side surface of the shell 10 and fits against to the ventilation portion 110a to support the ventilation portion 110a.

In this way, by providing the support mesh 50 at the inner side surface of the shell 10 and fitting the support mesh 50 against the ventilation portion 110a to support the ventilation portion 110a, structural strength of the ventilation portion 110a can be significantly enhanced. The support mesh 50 can not only prevent foreign objects from entering an interior of the shell 10 through the ventilation opening 110, but also lower a rupture risk of the ventilation portion 110a during falling or vibration. Thus, safety of the ventilation portion 110a is improved. In addition, the design of the support mesh 50 does not affect a heat dissipation function of the ventilation opening 110, ensuring that the battery module 30 and other electrical components can achieve effective heat dissipation during normal operation. As a result, the reliability and the service life of the energy storage power supply 100 can be further improved.

In an exemplary embodiment of the present disclosure, the support mesh 50 may be a protective structure disposed at the inner side surface of the shell 10 for covering the ventilation opening 110. The support mesh 50 may be a metallic mesh, a plastic mesh, or a mesh made of other materials with sufficient strength and air permeability. The support mesh 50 may be directly disposed at the inner side surface of the shell 10 through bonding, welding, or the like, or may be disposed at the inner side surface of the shell 10 by other mounting structures. For example, the support mesh 50 may be attached to the ventilation portion 110a by a sealant.

The number of support meshes 50 may be in one-to-one correspondence with the number of ventilation openings 110. For example, in a case where one ventilation opening 110 is provided, one support mesh 50 is provided. In a case where a plurality of ventilation openings 110 are provided, the same number of support meshes 50 are provided.

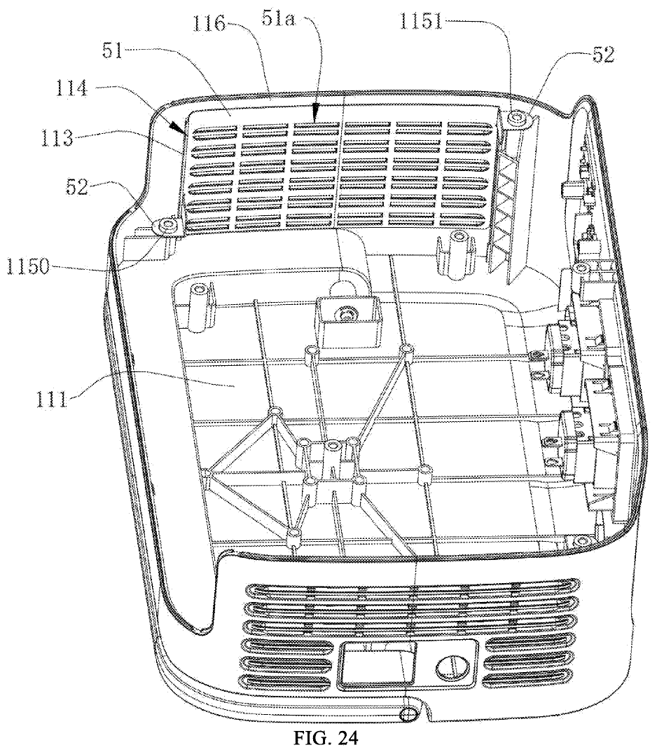

Referring to FIG. 24, in some embodiments, the first housing 11 has a ventilation opening 110, and the support mesh 50 is disposed at an inner side surface of the first housing 11.

In this way, when a region of the ventilation opening 110 of the shell 10 or the support mesh 50 is damaged, since the first housing 11 and the second housing 12 are detachably connected to each other, the user can replace the damaged first housing 11 or second housing 12 individually instead of the entire shell 10. Such a modular design not only reduces the maintenance costs, but also prolongs the service life of the energy storage power supply 100.

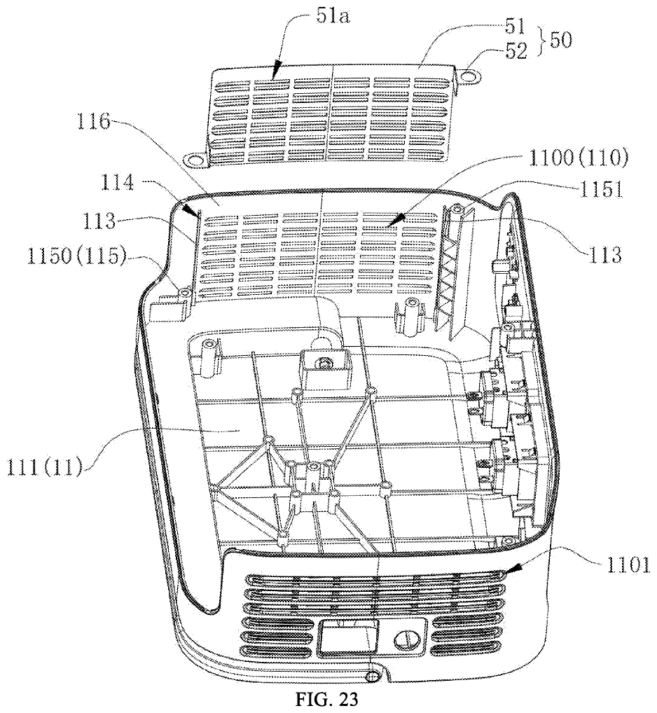

Referring to FIGS. 23 and 24, in some embodiments, the first housing 11 is provided with a limit strip 113 at the inner side surface of the first housing 11. The limit strip 113 and the inner side surface of the first housing 11 jointly define a second limit groove 114. The support mesh 50 is at least partially disposed in the second limit groove 114.

In this way, the support mesh 50 is fixed by the second limit groove 114, which can effectively prevent displacement and shaking of the support mesh 50 in the shell 10. Especially when the energy storage power supply 100 is dropped, vibrated, or impacted, it is ensured that the support mesh 50 constantly covers the ventilation opening 110, maintaining the protective function of the support mesh 50. In addition, the limit strip 113 may also serve as a guide structure when the support mesh 50 is mounted, which facilitates quick mounting of the support mesh 50.

In an exemplary embodiment of the present disclosure, the limit strip 113 may be a protrusion extending away from the inner side surface of the first housing 11. A plurality of limit strips 113 may be provided, for example, two, three, four, or even more limit strips 113 may be provided. The limit strip 113 and the first housing 11 may be of an integrally formed structure, which can reduce connection gaps and weak points, thereby enhancing structural rigidity of the limit strip 113. The limit strip 113 and the first housing 11 may also be of a separately formed structure, which can facilitate replacement of the limit strip 113 and thus increase a service life of the limit strip 113.

Referring to FIGS. 23 and 24, in some embodiments, two limit strips 113 are provided and are spaced apart from each other. Each of the two limit strips 113 extends from the first housing 11 towards the second housing 12. The support mesh 50 is at least partially disposed between the two limit strips 113.

In this way, the mounting position of the support mesh 50 can be more accurately defined by the two limit strips 113 spaced apart from each other, avoiding misalignment and inclination of the support mesh 50 during the mounting.

The spaced arrangement and extending direction design of the two limit strips 113 makes the mounting of the support mesh 50 simpler and faster. During the mounting, the support mesh 50 only needs to be aligned with a gap between the two limit strips 113 and inserted into the gap. During disassembling, the supporting mesh 50 only needs to be taken out from between the two limit strips 113. Such a design not only improves mounting and disassembling efficiency, but also reduces a risk of damage to the support mesh 50 caused by improper mounting.

In an exemplary embodiment of the present disclosure, a distance between the two limit strips 113 may be adjusted according to a thickness and width of the support mesh 50 to ensure stability of the mounting.

Referring to FIGS. 23 and 24, in some embodiments, the support mesh 50 includes a mesh portion 51 and a mounting portion 52 connected to the mesh portion 51. The mesh portion 51 is disposed in the second limit groove 114, and the mounting portion 52 is mounted at the first housing 11.

In this way, the design of the mounting portion 52 enables the support mesh 50 to be adapted to the shells 10 with different structures. Even if a size or shape of the second limit groove 114 of the shell 10 changes, the support mesh 50 can still be used normally as long as the mounting portion 52 can be fixed at the first housing 11. Such a design improves versatility and adaptability of the support mesh 50 and reduces the production costs.

By dividing the support mesh 50 into the mesh portion 51 and the mounting portion 52, the mounting of the support mesh 50 is more stable. The mesh portion 51 is disposed in the second limit groove 114 to ensure that the mesh portion 51 closely fits against the ventilation opening 110. The mounting portion 52 is directly fixed at the first housing 11, further enhancing overall stability of the support mesh 50 and avoiding the displacement or shaking of the support mesh 50 during the vibration or impact.

In an exemplary embodiment of the present disclosure, the mesh portion 51 is a main part of the support mesh 50 and is typically of a mesh structure, and the mesh portion 51 is configured to cover the ventilation opening 110. The mesh portion 51 allows air circulation while preventing the foreign objects from entering the interior of the shell 10 through the ventilation opening 110. The mesh portion 51 may be designed in various shapes and sizes, such as a rectangular-shaped mesh, a circular-shaped mesh, or an irregularly shaped mesh, to adapt to different designs of the ventilation opening 110.

The mounting portion 52 is another part of the support mesh 50 and is configured to fix the support mesh 50 at the first housing 11. The mounting portion 52 may be mounted at the first housing 11 through a bolt connection, bonding, welding, or other modes. One or more mounting portions 52 may be provided, for example, two, three, four, or even more mounting portions 52 may be provided.

Referring to FIGS. 22, 23, and 24, in some embodiments, the mesh portion 51 has a mesh hole 51a corresponding to the ventilation opening 110.

In this way, it is possible to prevent the mesh portion 51 from covering the ventilation opening 110, thereby avoiding affecting airflow circulation at the ventilation opening 110.

In an exemplary embodiment of the present disclosure, the mesh hole 51a may be designed in various shapes and sizes, such as a circular-shaped hole, a square hole, and other regularly shaped holes, or an irregularly shaped hole. The size and shape of the mesh hole 51a may be the same as or different from the size and shape of the ventilation opening 110.

Referring to FIGS. 23 and 24, in some embodiments, the first housing 11 is provided with a stud 115 that is mounted and connected to the second housing 12, and the mounting portion 52 is sleeved onto the stud 115.

In this way, by sleeving the mounting portion 52 onto the stud 115 instead of connecting the mounting portion 52 and the stud 115 by a connection component such as a bolt or a screw, use of connection components can be reduced, thereby lowering manufacturing costs of the energy storage power supply 100.

In an exemplary embodiment of the present disclosure, the stud 115 may be of a hollow post structure having a threaded hole. The stud 115 is structural member disposed at the first housing 11 and configured to be mounted and connected to the second housing 12, and the stud 115 serves as a support for the mounting portion 52 of the support mesh 50. A shape and size of the stud 115 may be designed according to mounting requirements, such as a cylindrical shape, a square shape, or a hexagonal shape. The stud 115 may be designed as an independent component fixed at the first housing 11, or may be a part of the first housing 11.

The sleeving may be interference fit or clearance fit, depending on the mounting requirements. The sleeving may be achieved by interference fit, clearance fit, or transition fit.

The mounting portion 52 may have a hole configured to be engaged with the stud 115, and a wall surface of the mounting portion 52 on which the hole is formed may be in contact with an outer surface of the stud 115. The stud 115 may have a threaded hole, and the threaded hole may be configured to be connected to a connection component such as a bolt or a screw. For example, the connection component is a bolt. During the connection between the first housing 11 and the second housing 12, the bolt may be engaged into the threaded hole of the stud 115, and therefore a head of the bolt can limit a position of the mounting portion 52 to complete fixing of the mounting portion 52.

Referring to FIGS. 23 and 24, in some embodiments, the first housing 11 includes a first base plate 111 and a first side plate 116 connected to the first base plate 111. The first side plate 116 has a ventilation opening 110. The stud 115 includes a first stud 1150 and a second stud 1151. The first stud 1150 is disposed at the first base plate 111. The second stud 1151 is disposed at the first side plate 116. The first stud 1150 is located at a higher level than the second stud 1151. Two mounting portions 52 are provided. One of the two mounting portions 52 is sleeved at the first stud 1150, and the other one of the two mounting portions 52 is sleeved at the second stud 1151.

In this way, if the first stud 1150 and the second stud 1151 are located at the same level, a side of the support mesh 50 is likely to form a free end, thereby tending to be separated from the inner side surface of the shell 10. By locating the first stud 1150 and the second stud 1151 at different levels, the support mesh 50 can be fixed more stably, thereby preventing the support mesh 50 from detaching from the inner side surface of the shell 10 when an external force is applied to the support mesh 50, thereby avoiding a functional failure of the support mesh 50.

In an exemplary embodiment of the present disclosure, for the energy storage power supply 100 of the rectangular-parallelepiped shape, when the energy storage power supply 100 is placed horizontally, the first base plate 111 is located above the first side plate 116, and the first base plate 111 is substantially parallel to a horizontal plane. In this case, a position height of each of the first stud 1150 and the second stud 1151 refers to a height of each of the first stud 1150 and the second stud 1151 relative to the horizontal plane.

In some embodiments, an airflow flowing through the ventilation opening 110 is formed by the cooling fan 212. In this way, the airflow formed by the cooling fan 212 can flow out of the interior of the shell 10 through the ventilation opening 110, thereby speeding up airflow circulation between the interior and exterior of the shell 10. Thus, the heat dissipation efficiency is improved.

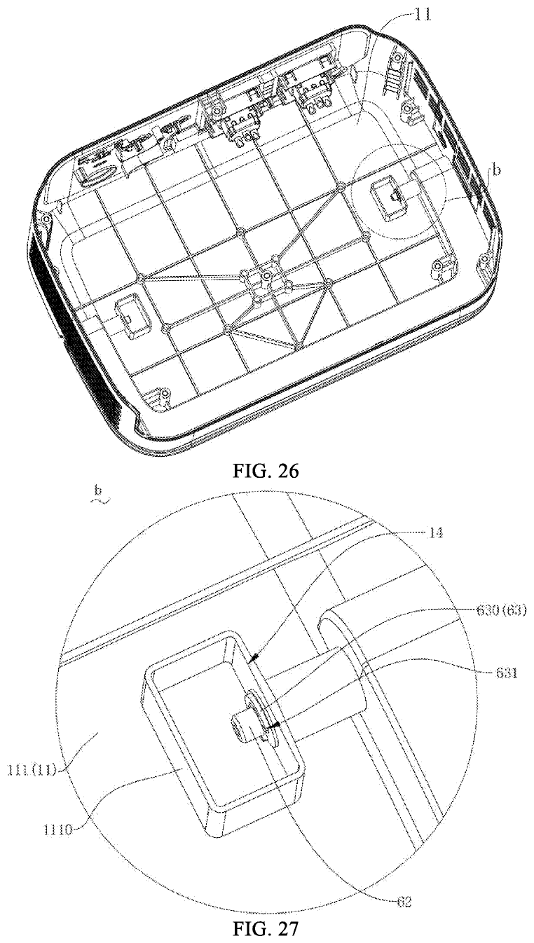

Referring to FIGS. 1, 25, 26, and 27, in some embodiments, the energy storage power supply 100 further includes a handle assembly 60 and a shielding member 25. The shell 10 has an open slot 14 formed in the accommodation chamber 13. The handle assembly 60 includes a handle 61, a rotatable shaft 62, and a fixing member 63. The rotatable shaft 62 is inserted into the handle 61 and the shell 10. The handle 61 rotates relative to the shell 10 through the rotatable shaft 62. The rotatable shaft 62 has an end extending into the open slot 14. The fixing member 63 is disposed at the rotatable shaft 62. The fixing member 63 is located in the open slot 14 and abuts with a slot wall of the open slot 14 to restrict a movement of the rotatable shaft 62 in an axial h direction of the rotatable shaft 62 relative to the shell 10. The shielding member 25 is disposed in the accommodation chamber 13 and closes an opening of the open slot 14.

In this way, by disposing the fixing member 63 in the open slot 14 and configuring the shielding member 25 to close the opening of the open slot 14, accidental detachment of the fixing member 63 is prevented, protecting the internal assemblies of the energy storage power supply 100, thereby improving safety of the energy storage power supply 100.

In an exemplary embodiment of the present disclosure, one or more open slots 14 may be provided, for example, two, three, four, or even more open slots 14 may be provided. A shape of the open slot 14 may be designed according to requirements, for example, the open slot 14 may be designed into a regular shape such as a circular shape or a square shape, or the open slot 14 may be designed into an irregular shape.

The handle assembly 60 is configured to facilitate the user to carry the energy storage power supply 100, and ensure stability and reliability of the handle 61 through the rotatable shaft 62 and the fixing member 63 at the same time. The handle 61 is a part held by the user and may be made of a robust and durable material, such as plastic or rubber. The handle 61 is configured to facilitate the user to carry the energy storage power supply 100.

The rotatable shaft 62 is a component that connects the handle 61 and the shell 10. The shape and material of the rotatable shaft 62 may be selected according to requirements. For example, the rotatable shaft 62 can be a cylindrical-shaped metal or a plastic shaft.

The fixing member 63 is a component for fixing the rotatable shaft 62, such as a snap ring 630 and a nut. The fixing member 63 may be a ring-shaped member made of metal or plastic. The fixing member 63 may be in direct contact with or may be in indirect contact with the slot wall of the open slot 14. For example, a friction gasket may be provided between the fixing member 63 and the slot wall of the open slot 14, and the friction gasket may abut with two side surfaces of the fixing member 63 adjacent to the slot wall of the open slot 14. In this way, the friction gasket can avoid friction between the fixing member 63 and the slot wall of the open slot 14, thereby improving a service life of the fixing member 63.

The shielding member 25 is a component for sealing the opening of the open slot 14 and may be a plate-like, sheet-like, mesh-like, or other-shaped structure made of materials such as metal, plastic, or rubber. The shielding member 25 is configured to prevent detachment of the fixing member 63 and protect the assemblies inside the open slot 14 from interference by external foreign objects.

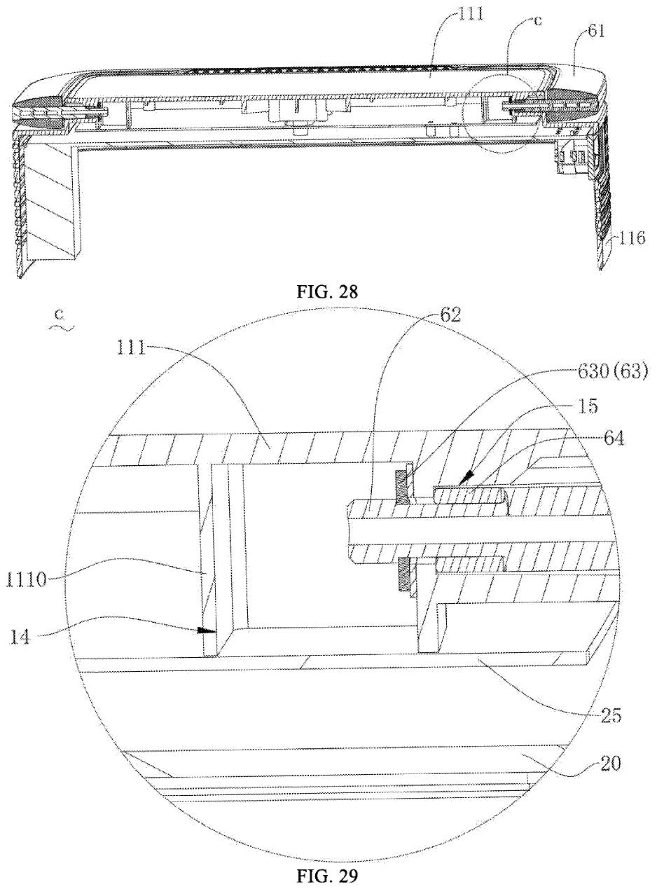

Referring to FIGS. 28 and 29, in some embodiments, the shielding member 25 is disposed at the circuit board module 20.

In this way, by disposing the shielding member 25 at the circuit board module 20, protection of the circuit board module 20 can be further enhanced. As a core component of the energy storage power supply 100, the circuit board module 20 is more susceptible to external interference. By providing the shielding member 25, an impact of external factors on the circuit board module 20 can be effectively prevented, thereby improving reliability of circuit board module 20.

In an exemplary embodiment of the present disclosure, the shielding member 25 is mounted at the circuit board module 20 through mechanical fixing, bonding, or other means. The shielding member 25 may be directly connected to the circuit board module 20. For example, the shielding member 25 may be fixed at the circuit board module 20 through a screw, a buckle, a glue, etc., or may be connected to an inner wall of the shell 10 to be suspended on the circuit board module 20.

Referring to FIG. 27, in some embodiments, the fixing member 63 includes a snap ring 630 provided with a catching opening 631 in a circumferential direction of the snap ring 630, and the snap ring 630 is snapped at the rotatable shaft 62.

In this way, since the fixing member 63 adopts the design of the snap ring 630 with the catching opening 631 in the circumferential direction of the snap ring 630, and the snap ring 630 is snapped at the rotatable shaft 62, an axial movement of the rotatable shaft 62 can be effectively restricted. Thus, stability of the fixing member 63 is improved, avoiding loosening and disengagement of the fixing member 63 during use.

In an exemplary embodiment of the present disclosure, the snap ring 630 can achieve axial fixing of the rotatable shaft 62 through the engagement between the catching opening 631 of the snap ring 630 and the rotatable shaft 62. Due to the presence of the catching opening 631, the snap ring 630 can undergo elastic deformation. The elastic deformation of the snap ring 630 enables the snap ring 630 to be easily mounted and removed. The snap ring 630 may be designed in various types, such as a shaft snap ring 630 and a hole snap ring 630, to adapt to different mounting positions and fixing requirements.

The catching opening 631 may be one or more grooves. The catching opening 631 is configured to be engaged with a corresponding structure of the rotatable shaft 62 and is snapped into a recess of the rotatable shaft 62 through the elastic deformation to achieve the fixing. The catching opening 631 may be designed to be uniformly distributed or non-uniformly distributed to adapt to the rotatable shafts 62 with different diameters and fixing requirements. The catching opening 631 may be of a circular shape, a square shape, or other suitable shapes.

Referring to FIG. 29, in some embodiments, the shell 10 has an adapter hole 15, and the rotatable shaft 62 is inserted into the adapter hole 15. The handle assembly 60 further includes a damping member 64 sleeved at the rotatable shaft 62. The damping member 64 is located in the adapter hole 15 and is in contact with a hole wall of the adapter hole 15.

In this way, the damping member 64 can provide a certain resistance, preventing the handle 61 from being too loose when rotating. Thus, a rotation speed and strength of the handle 61 are controlled, thereby improving operational stability of the energy storage power supply 100. Moreover, the resistance provided by the damping member 64 can give the handle 61 a certain damping feeling when rotating, improving user experience when operating the handle 61 and making the operation smoother and more controllable.

In an exemplary embodiment of the present disclosure, the adapter hole 15 is a hole of the shell 10 for insertion of the rotatable shaft 62. The adapter hole 15 can provide a mounting position for the rotatable shaft 62 and be engaged with the damping member 64 to ensure stability of the rotatable shaft 62 and a damping effect during rotation. The shape and size of the adapter hole 15 may be adjusted according to the specific design of the rotatable shaft 62 and the damping member 64 to ensure a best engagement effect. The adapter hole 15 may be designed in a circular shape, an oval shape, or other suitable shape.

The damping member 64 is a component for providing resistance. The damping member 64 may be made of rubber, plastic, or other materials with damping properties. The damping member 64 is configured to, by contacting with a hole wall of the adapter hole 15, provide appropriate resistance and control the rotation speed and strength of the handle 61 to improve stability and accuracy of the operation. The damping member 64 may be designed in various types, such as a damping ring and damping sleeve, to adapt to different rotatable shafts 62 and adapter holes 15. The material and shape of the damping member 64 may be selected as needed to achieve different damping effects. The damping member 64 may be fixed at the rotatable shaft 62 through interference fit, bonding, or other means to ensure no loosening and detachment of the damping member 64 during use.

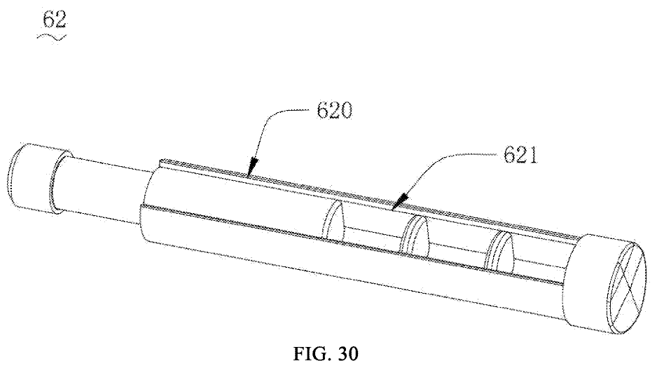

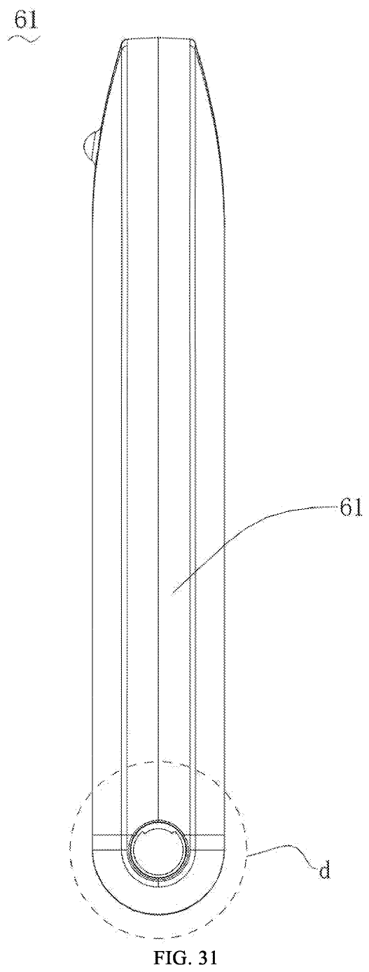

Referring to FIGS. 30, 31, and 32, in some embodiments, the handle 61 has a pivot hole 610. One of a hole wall of the pivot hole 610 and a circumferential surface of the rotatable shaft 62 has a stop groove 620, and the other one of the pivot hole 610 and a circumferential surface of the rotatable shaft 62 is provided with a stop protrusion 611. The stop protrusion 611 is snapped into the stop groove 620 to enable the handle 61 and the rotatable shaft 62 to rotate synchronously.

In this way, by providing the stop groove 620 and the stop protrusion 611 between the hole wall of the pivot hole 610 of the handle 61 and the circumferential surface of the rotatable shaft 62, synchronous rotation between the handle 61 and the rotatable shaft 62 is ensured. Such a design can effectively prevent relative sliding between the handle 61 and the rotatable shaft 62 and thus improve reliability of operation.

In an exemplary embodiment of the present disclosure, the pivot hole 610 is configured to provide a mounting position for the rotatable shaft 62 and be engaged with the rotatable shaft 62 to allow for a rotation function of the handle 61. A shape and size of the pivot hole 610 may be adjusted according to the specific design of the rotatable shaft 62 to ensure a best engagement effect. The pivot hole 610 may be designed in a circular shape, an oval shape, or other suitable shapes.

The stop groove 620 is a groove in the hole wall of the pivot hole 610 or in the circumferential surface of the rotatable shaft 62. The stop groove 620 is configured to be engaged with the stop protrusion 611 to prevent the relative sliding between the handle 61 and the rotatable shaft 62 to ensure the synchronous rotation between the handle 61 and the rotatable shaft 62. The stop groove 620 may be designed in various shapes, such as a circular shape, a square shape, and a dovetail shape, to adapt to different fixing requirements. A depth and width of the stop groove 620 may be adjusted according to actual needs.

The stop protrusion 611 is a protrusion on the hole wall of the pivot hole 610 or on the circumferential surface of the rotatable shaft 62. The stop protrusion 611 is configured to be engaged with the stop groove 620 to prevent the relative sliding between the handle 61 and the rotatable shaft 62 to ensure the synchronous rotation between the handle 61 and the rotatable shaft 62. The stop protrusion 611 may be designed in various shapes, such as a circular shape, a square shape, and a dovetail shape to adapt to different fixing requirements. A height and width of the stop protrusion 611 may be adjusted according to actual needs.

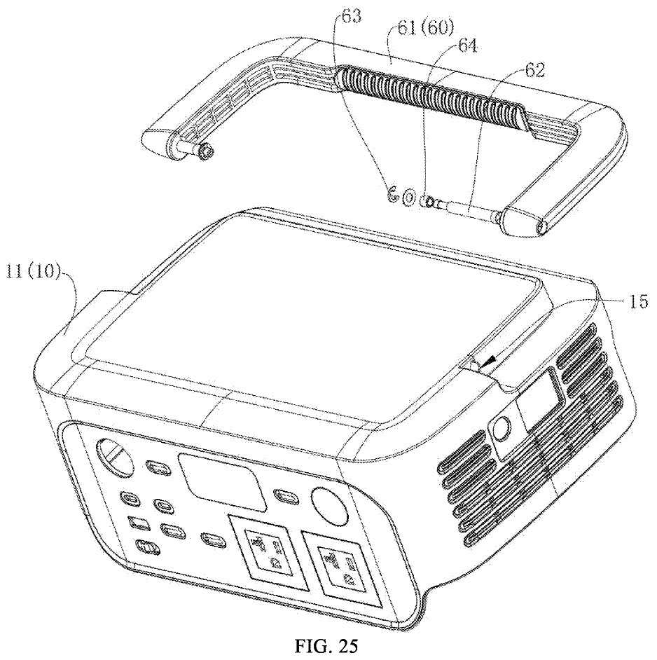

Referring to FIGS. 25 and 27, in some embodiments, the handle 61 is disposed at the first housing 11, and the first housing 11 has an open slot 14.

In this way, during assembling, the handle 61 and the first housing 11 may be assembled first, and then the assembled structure as a whole is connected to the second housing 12. Such a step-by-step assembling manner can improve the assembling efficiency and reduce assembling errors. Moreover, the handle 61 and the open slot 14 are both disposed at the first housing 11, which can reduce manufacturing complexity of the handle assembly 60 and thus improve the manufacturing efficiency.

Referring to FIGS. 25 and 27, in some embodiments, the first side plate 116 is connected to the second housing 12, and the first base plate 111 is provided with an enclosure wall 1110 at an inner surface of the first base plate 111. The enclosure wall 1110 defines the open slot 14, and the handle 61 is disposed at the first base plate 111.

In this way, the enclosure wall 1110 can not only provide structural support for the open slot 14, but also serve a certain protective function to prevent external objects from directly striking the rotatable shaft 62 and the fixing member 63 in the open slot 14. Thus, the components located inside the open slot 14 are protected.

In an exemplary embodiment of the present disclosure, the enclosure wall 1110 may be disposed at the inner surface of the first base plate 111 through mechanical fixing. For example, the enclosure wall 1110 may be disposed at the inner surface of the first base plate 111 through a bolt connection, bonding, snapping, or the like. The enclosure wall 1110 and the first base plate 111 may also be of an integrally formed structure, which can reduce connection gaps and weak points, thereby enhancing structural rigidity of the enclosure wall 1110.

The handle 61 may be disposed at the first base plate 111 through the rotatable shaft 62, that is, the handle 61 may rotate relative to the first base plate 111 through the rotatable shaft 62.

Referring to FIG. 30, in some embodiments, the rotatable shaft 62 has at least one weight-reducing groove 621.

In this way, since the at least one weight-reducing groove 621 is formed at the rotatable shaft 62, a weight of the rotatable shaft 62 can be effectively reduced. Thus, a weight of the entire energy storage power supply 100 can be reduced. Therefore, the portability of the energy storage power supply 100 can be improved.

In an exemplary embodiment of the present disclosure, the weight reduction groove 621 may be designed in various shapes and sizes, such as a rectangular shape, a semicircular shape, and a trapezoidal shape, to adapt to different weight reduction and heat dissipation requirements. A depth and width of the weight-reducing groove 621 can be adjusted according to actual needs. One, two, three, or even more weight-reducing grooves 621 may be provided.

The weight-reducing groove 621 may be formed by mechanical processing, such as turning or drilling. The weight reduction groove 621 may also be formed through molding. For example, for a plastic rotatable shaft 62, the weight-reducing groove 621 may be directly formed during injection molding through a design of an injection mold.

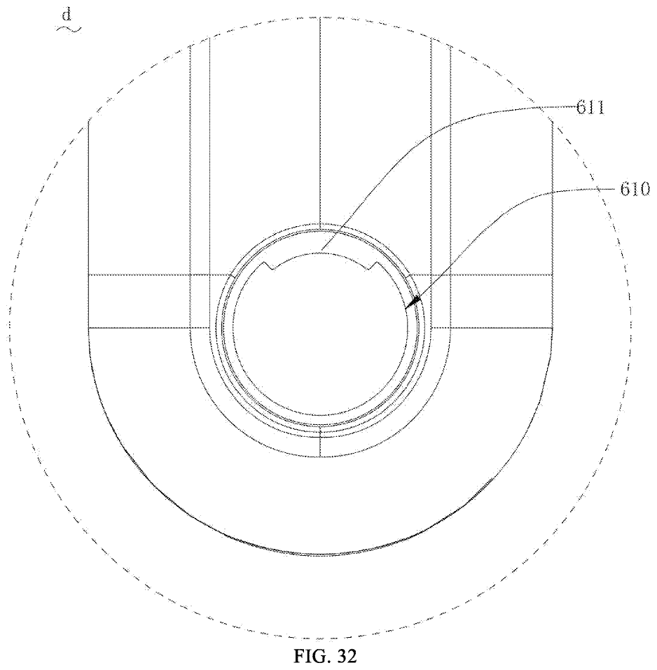

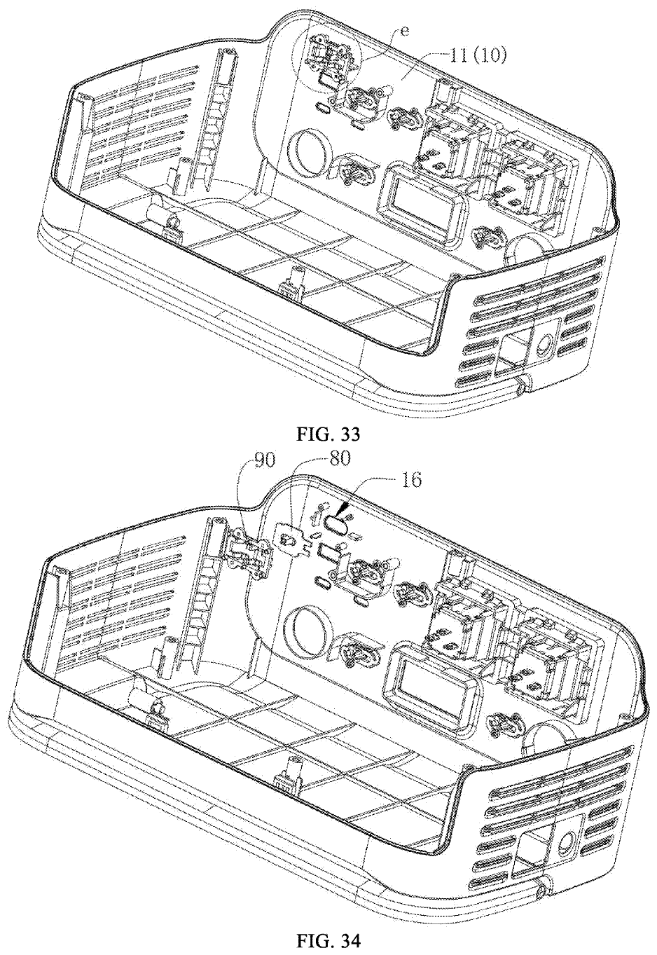

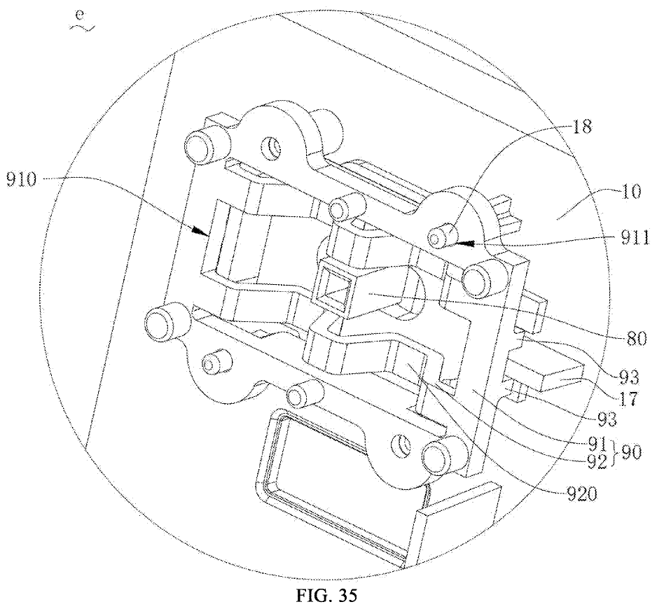

Referring to FIG. 33, FIG. 34, and FIG. 35, in some embodiments, the energy storage power supply 100 further includes a slide button 80 and an elastic abutment member 90. The shell 10 has an assembling hole 16; the slide button 80 is slidably mounted in the assembling hole 16; and the elastic abutment member 90 is disposed in the shell 10 and abuts against the slide button 80.

In this way, the existence of the elastic abutment member 90 can provide a uniform elastic force, and therefore a stable abutment force is consistently applied to the slide button 80 during toggling. Such a design can effectively reduce a poor tactile feel of the slide button 80 when the slide button 80 is toggled, making the toggling force more uniform, thereby preventing the user from experiencing obvious step differences or uneven resistance during operation. Thus, a risk of misoperation caused by uneven force is reduced. Thus, the user's tactile feel during the operation is improved.

In an exemplary embodiment of the present disclosure, the assembling hole 16 is configured to provide a mounting position for the slide button 80 and limit a movement trajectory of the slide button 80 to allow the slide button 80 to slide within the shell 10. A shape and size of the assembling hole 16 may be designed according to a shape and size of the slide button 80. For example, the assembling hole 16 may be a linear hole, a curved hole, or other types of holes. A surface of the assembling hole 16 may be smoothed to reduce friction of the slide button 80 during sliding.

The slide button 80 is a slidable mechanical component for controlling a switch or function switching of the energy storage power supply 100. The slide button 80 may be driven to slide along a path defined by the assembling hole 16. The slide button 80 may be made of a plastic or metal material to meet different usage requirements.

The elastic abutment member 90 is an elastic component for providing a stable abutment force. The elastic abutment member 90 may be made of various elastic materials, such as plastic, rubber, or silicone.

Referring to FIG. 35, in some embodiments, the elastic abutment member 90 includes a body 91 and an elastic arm 92 disposed at the body 91. The body 91 is mounted at the shell 10, and the elastic arm 92 abuts against the slide button 80.

In this way, the elastic abutment member 90 is configured into the body 91 and the elastic arm 92. The body 91 is mounted at the shell 10, and the elastic arm 92 directly abuts against the slide button 80. This allows the elastic arm 92 to more accurately control a distribution of an abutment force, thereby further improving uniformity of the force during the toggling process of the slide button 80. The elastic deformation of the elastic arm 92 can dynamically adjust the abutment force, thereby reducing the poor tactile feel when operating the slide button 80 due to changes in structural gaps or friction.

In an exemplary embodiment of the present disclosure, the body 91 may be connected to the elastic arm 92 through mechanical fixation, such as bonding, welding, or snapping. The body 91 and the elastic arm 92 may also be of an integrally formed structure, which can reduce connection gaps and weak points. Thus, overall structural rigidity of the elastic abutment member 90 can be improved. The body 91 may be mounted at the shell 10 through bonding, welding, or a threaded connection.

The elastic arm 92 may be made of a variety of elastic materials, such as spring steel, rubber, and silicone. A shape and size of the elastic arm 92 may be designed according to actual needs. For example, the elastic arm 92 may be corrugated, a spring-shaped, sheet-shaped, etc.

The abutment refers to a state in which the elastic arm 92 exerts a pressure on the slide button 80. Through the abutment, the elastic arm 92 can provide a uniform abutment force to the slide button 80, ensuring that the slide button 80 feels smooth when being toggled, thereby reducing the poor tactile feel when operating the slide button 80. Thus, the user experience is improved.

Referring to FIG. 35, in some embodiments, the body 91 is in a frame shape and has a hollow hole 910, and two ends of the elastic arm 92 are connected to a hole wall of the hollow hole 910.

In this way, the body 91 of the elastic abutment member 90 is in the frame shape and has the hollow hole 910, and the two ends of the elastic arm 92 are connected to the hole wall of the hollow hole 910. Such a design makes the deformation of the elastic arm 92 more concentrated and stable when subjected to a force, thereby further optimizing uniformity of the force exerted on the slide button 80 when being toggled. Due to the presence of the hollow hole 910, the deformation of the elastic arm 92 can be more uniform, reducing local stress concentration, and further improving the poor tactile feel when operating the slide button 80.

In an exemplary embodiment of the present disclosure, the body 91 is a component with a frame structure, which may be of a rectangular, square, or other polygonal ring structure.

The hollow hole 910 is one or more openings in the body 91 for connecting the elastic arm 92 and optimizing the deformation distribution. Due to the presence of the hollow hole 910, use of materials can be reduced, and a weight can be lightened. Meanwhile, the two ends of the elastic arm 92 are allowed to be connected to the hole wall of the hollow hole 910, and therefore the deformation of the elastic arm 92 when subjected to the force is more concentrated and uniform. A shape and size of the hollow hole 910 may be designed according to actual needs. For example, the hollow hole 910 may be of a circular shape, a square shape, an oval shape, etc. The number of hollow holes 910 may also be adjusted as needed. For example, one or more hollow holes 910 may be provided. For example, two, three, four, or even more hollow holes 910 may be provided.

The two ends of the elastic arm 92 may be connected to the hole wall of the hollow hole 910 through bonding, a threaded connection, insertion connection, or other means.

Referring to FIG. 35, in some embodiments, the elastic arm 92 is of a corrugated shape and has a trough portion 920, and the trough portion 920 abuts with the slide button 80.

In this way, the corrugated structure makes the deformation of the elastic arm 92 more uniform when subjected to the force, and the trough portion 920 can provide a more stable abutment force, thereby further improving the uniformity of the force applied to the slide button 80 when being toggled. Such a design can effectively reduce the poor tactile feel when operating the slide button 80, making the toggling force more uniform, thereby significantly improving the user experience.

In an exemplary embodiment of the present disclosure, the trough portion 920 is a lower portion in the elastic arm 92 of the corrugated shape and is located in a depression of corrugation. The trough portion 920 directly abuts against the slide button 80 to provide a uniform abutment force through a position and shape of the trough portion 920. The design of the trough portion 920 can ensure that the deformation of the elastic arm 92 when subjected to the force is more concentrated and stable, thereby reducing the poor tactile feel when operating the slide button 80 and improving the user's operating tactile feel.

Referring to FIG. 35, in some embodiments, the shell 10 is provided with a support table 17 at an inner surface of the shell 10, and the body 91 abuts with the support table 17.

In this way, the support table 17 is disposed at the inner surface of the shell 10, and the body 91 of the elastic abutment member 90 abuts with the support table 17. Such a design provides an additional support point for the elastic abutment member 90, allowing the elastic abutment member 90 to be more securely mounted in the shell 10, thereby further improving overall structural stability of the elastic abutment member 90.

In an exemplary embodiment of the present disclosure, the inner surface is a surface of the shell 10 that faces towards the internal components of the energy storage power supply 100. The support table 17 is a protruding structure at the inner surface of the shell 10 and is configured to support the body 91 of the elastic abutment member 90. The support table 17 and the inner surface of the shell 10 may be integrally formed, or may be connected to each other through mechanical fixation, such as bonding, a bolt connection, or snap-fit. One or more support tables 17 may be provided, for example, two, three, four, or even more support tables 17 may be provided. The support table 17 may have different shapes and sizes. The support table 17 may be of a regular shape such as a circular shape, a square shape, or an elongated shape, or may be of an irregular shape.

Referring to FIG. 35, in some embodiments, the elastic abutment member 90 includes two protruding blocks 93 disposed at the body 91. The two protruding blocks 93 are spaced apart from each other, and the support table 17 is sandwiched between the two protruding blocks 93.

In this way, with the two protruding blocks 93 spaced apart from each other, the support table 17 can be accurately sandwiched between the two protruding blocks 93. Such a structure can ensure accurate positioning of the elastic abutment member 90 during the mounting, reducing mounting errors, and improving assembling efficiency. In addition, the elastic abutment member 90 includes the two protruding blocks 93 spaced apart from each other, and the support table 17 is sandwiched between the two protruding blocks 93. Such a design provides a more stable support for the elastic abutment member 90 to ensure no displacement or shaking of the elastic abutment member 90 within the shell 10, thus further improving the overall structural stability.

The protruding block 93 is a protruding part of the body 91 of the elastic abutment member 90 and is configured to cooperate with the support table 17 to provide stable support and positioning. The protruding blocks 93 may have different shapes and sizes, such as a circular shape, a square shape, and an elongated shape. The protruding block 93 and the body 91 of the elastic abutment member 90 may be integrally formed, or the protruding block 93 may be a separate component that is fixed at the body 91 through welding, bonding, or other means.

The sandwiching of the support table 17 may be achieved in different ways, such as direct sandwiching or sandwiching via an intermediate component. Sandwiching strength may be controlled by adjusting a shape and size of the protruding block 93.

Referring to FIG. 35, in some embodiments, the body 91 has a through hole 911, and the shell 10 is provided with a mounting post 18. The mounting post 18 is inserted into the through hole 911.

In this way, during production, the elastic abutment member 90 may be fixed at the shell 10 through the engagement between the mounting post 18 and the through hole 911 to form a pre-assembled assembly. In this way, this pre-assembled component may be used directly when subsequently assembled with other components, greatly improving assembling efficiency and convenience.

In an exemplary embodiment of the present disclosure, the through hole 911 is a through hole in the body 91 of the elastic abutment member 90 and is configured to be inserted into the mounting post 18. A shape and size of the through hole 911 may be designed according to a shape and size of the mounting post 18, such as a circular shape, a square shape, and an oval shape. The number of through holes 911 may be set as desired. In order to stably fix the mounting column 18, a plurality of through holes 911 may be provided. For example, two, three, four, or even more through holes 911 may be provided.

The mounting post 18 is a protruding structure of the shell 10 and is configured to be inserted into the through hole 911 to allow for fixing of the elastic abutment member 90. The mounting posts 18 may have different shapes and sizes, such as a round shape, a square shape, and an elongated shape. The number of mounting posts 18 may be adapted to the number of through holes 911. The mounting post 18 and the shell 10 may be integrally formed, or the mounting post 18 may be a separate component that is fixed at the shell 10 through welding, bonding, etc.

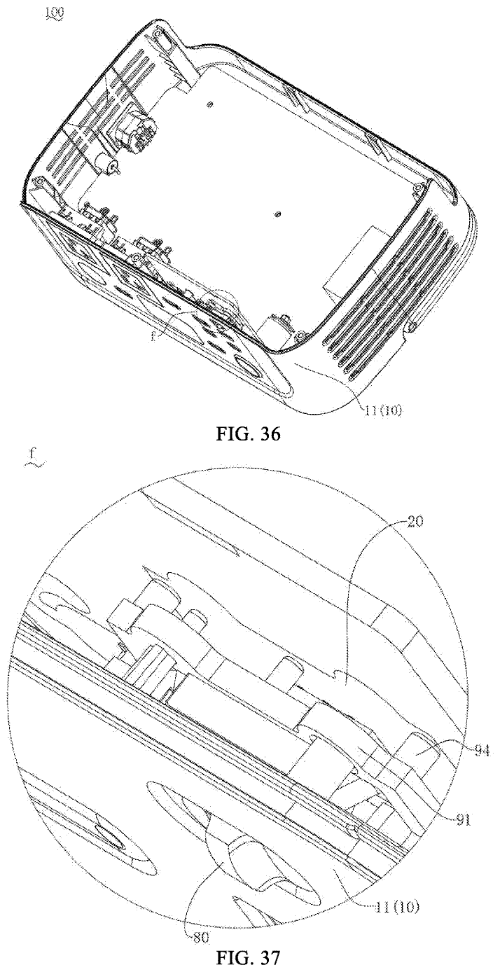

Referring to FIGS. 35, 36, and 37, in some embodiments, the elastic abutment member 90 includes a pressing block 94 disposed at a side of the body 91 away from the slide button 80. The elastic abutment member 90 is sandwiched between the shell 10 and the circuit board module 20, and the pressing block 94 abuts with the circuit board module 20.

In this way, by abutting the pressing block 94 with the circuit board module 20, the elastic abutment member 90 is stably sandwiched between the shell 10 and the circuit board module 20. Such a design can ensure no displacement and shaking of the elastic abutment member 90 within the shell 10, thus ensuring a stable pressing effect of the elastic abutment member 90 on the slide button 80. Moreover, the elastic abutment member 90 can be compressed by means of the circuit board module 20 without other additional components. This can not only improve a space utilization rate in the shell 10 but also lower the manufacturing cost.

In an exemplary embodiment of the present disclosure, the pressing block 94 is a protruding part of the body 91 of the elastic abutment member 90 and is configured to be in contact with the circuit board module 20 and provide a force. The pressing blocks 94 may have different shapes and sizes, such as a round shape, a square shape, and an elongated strip.

The sandwiching means that the elastic abutment member 90 is sandwiched between the shell 10 and the circuit board module 20 and is fixed by a pressure between the shell 10 and the circuit board module 20.

Referring to FIG. 37, in some embodiments, each of the slide button 80 and the circuit board module 20 is disposed at the first housing 11.

In this way, by disposing each of the slide button 80 and the circuit board module 20 at the first housing 11, the assembling process is simpler. During assembling, the slide button 80 and the circuit board module 20 may be mounted at the first housing 11 first, and then connected to the second housing 12, which reduces the complexity of the assembling steps and thus improves the assembling efficiency.

In an exemplary embodiment of the present disclosure, the slide button 80 and the circuit board module 20 may be disposed at the first housing 11 through bolt connection, snap-fit, or bonding.

Referring to FIG. 35, in some embodiments, the body 91 is fixed at the shell 10 by a fastener.

In this way, the body 91 of the elastic abutment member 90 is fixed at the shell 10 by the fastener, thereby ensuring stability of the mounting of the elastic abutment member 90 in the shell 10. The use of the fastener can prevent the elastic abutment member 90 from being displaced or loosened during use, thereby ensuring a stable abutment effect of the elastic abutment member 90 on the slide button 80.

In an exemplary embodiment of the present disclosure, the fastener may include a bolt, a screw, a nut, a rivet, etc. The shell 10 may be provided with a corresponding structure such as a threaded hole or a riveting hole. One or more fasteners may be provided. For example, two, three, four, or even more fasteners may be provided.

Referring to FIGS. 5, 6, and 7, according to embodiments of the present disclosure, an energy storage power supply 100 includes a first housing assembly 103 and a second housing assembly 104. The first housing assembly 103 includes a first housing 11 and a circuit board module 20 fixed at the first housing 11. The second housing assembly 104 includes a second housing 12 and a battery module 30 fixed at the second housing 12. The first housing 11 and the second housing 12 are detachably connected to each other and define an accommodation chamber 13. Each of the circuit board module 20 and the battery module 30 is located in the accommodation chamber 13.

In this way, the modular design of the first housing assembly 103 and the second housing assembly 104 allows the circuit board module 20 and the battery module 30 to be assembled separately and then mounted as a whole, which simplifies an overall assembling process and improves assembling efficiency.

During assembling, the first housing 11 and the circuit board module 20 are assembled into the first housing assembly 103, and the second housing 12 and the battery module 30 are assembled into the second housing assembly 104. Then, the first housing assembly 103 and the second housing assembly 104 are assembled together through the first housing 11 and the second housing 12.

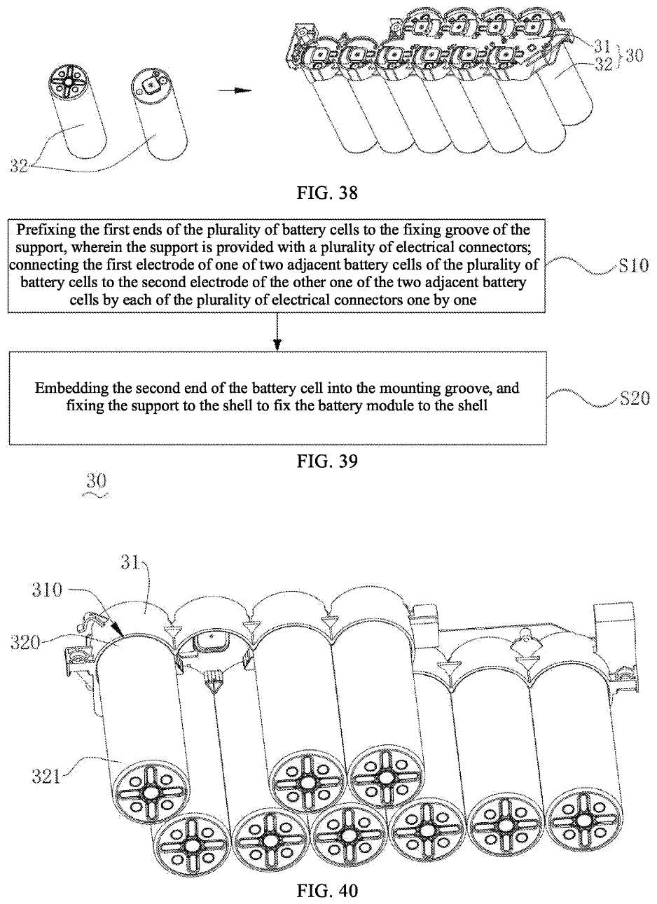

Referring to FIGS. 38, 39, 40, and 41, according to embodiments of the present disclosure, an energy storage power supply 100 includes a shell 10, a support 31, and a plurality of battery cells 32. Each of the plurality of battery cells 32 has a first end 320 and a second end 321 opposite to the first end 320, and each of the plurality of battery cells 32 includes a first electrode 3200 and a second electrode at the first end 320 of the battery cell 32. The support 31 has a fixing slot 310, and the shell 10 has a plurality of mounting grooves 121. According to the embodiments of the present disclosure, an assembling method for the energy storage power supply 100 includes actions at blocks S10 and S20.

At block S10, the first ends 320 of the plurality of battery cells 32 are pre-fixed to the fixing groove 310 of the support 31. The support 31 is provided with a plurality of electrical connectors 33. The first electrode 3200 of one of two adjacent battery cells 32 of the plurality of battery cells 32 is connected to the second electrode of the other one of the two adjacent battery cells 32 by each of the plurality of electrical connectors 33 one by one.

At block S20, the second end 321 of the battery cell 32 is embedded into the mounting groove 121, and the support 31 is fixed to the shell 10 to fix the battery module 30 to the shell 10.

In the assembling method for the energy storage power supply 100 according to the embodiments of the present disclosure, the first end 320 of the battery cell 32 is first pre-fixed to the fixing groove 310 of the support 31, and the first electrode of the battery cell 32 and the second electrode of an adjacent battery cell 32 are connected to each other by the electrical connector 33 at the support 31 to form the battery module 30; and then the battery module 30 is fixed to the shell 10 as a whole. This method avoids direct welding operations at the shell 10, reducing a risk of damage to the shell 10 caused by welding, and improving assembling efficiency. Meanwhile, by providing the fixing slot 310 and the electrical connector 33 at the support 31, positions of the battery cell 32 and the electrical connector 33 can be rationally arranged, making the battery module 30 more compact, thereby facilitating reducing an overall volume of the energy storage power supply 100.

In an exemplary embodiment of the present disclosure, during the assembling, the first end 320 of the battery cell 32 may be pre-fixed into the fixing groove 310 of the support 31 through a buckle, a bolt, bonding, or the like. The electrical connector 33 can connect the first electrode 3200 of one of the two adjacent battery cells 32 to the second electrode of the other one of the two adjacent battery cells 32 one by one through welding or wire connection to form the battery module 30. The support 31 may be fixed at the shell 10 through a bolt connection, bonding, a snap-fit connection, or the like.

During pre-fixing, the fixing groove 310 and the battery cell 32 may be in an interference fit. In an exemplary embodiment of the present disclosure, glue is applied in the fixing groove 310 to allow for the fixing through the gluing. In another exemplary embodiment of the present disclosure, a jig is provided, the battery cell 32 is pre-fixed to the support 31 through a connection between the jig and the support 31, and then the jig is removed after welding is completed.

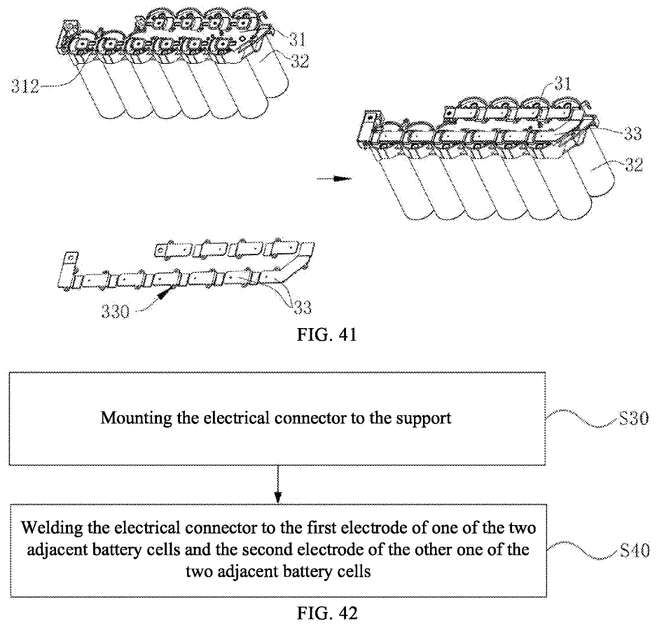

Referring to FIGS. 41 and 42, in some embodiments, the assembling method includes actions at blocks S30 and S40.

At block S30, the electrical connector 33 is mounted to the support 31.

At block S40, the electrical connector 33 is welded to the first electrode 3200 of one of the two adjacent battery cells 32 and the second electrode of the other one of the two adjacent battery cells 32.

It should be noted that there is no temporal relationship among blocks S30, S40, and S10. For example, block S30 may be prior to block S10 or subsequent to block S10. Block S40 may be prior to block S10 or subsequent to block S10.

In this way, the electrical connector 33 is first mounted at the support 31, and then the first electrode 3200 of one of the two adjacent battery cells 32 and the second electrode of one of the two adjacent battery cells 32 are welded. This method can ensure that the electrical connector 33 is mounted in a correct position, avoiding displacement of the battery cell 32 caused by a movement of the electrical connector 33 during welding, thus ensuring that the battery cell 32 is mounted in a correct position. Moreover, the electrical connection between the first electrode 3200 and the second electrode can be stabilized through the welding.

In an exemplary embodiment of the present disclosure, the electrical connector 33 may be mounted at the support 31 through an insertion connection, snap-fit connection, etc. The welding is a process that combines materials through heating or pressing to enhance connection strength and conductivity between the electrical connector 33 and the first electrode 3200 and connection strength and conductivity between the electrical connector 33 and the second electrode. The welding ensures long-term stability and reliability of the electrical connection. The welding method may be resistance welding, laser welding, ultrasonic welding, etc.

Referring to FIG. 41, in some embodiments, the mounting the electrical connector 33 at the support 31 includes:

engaging a first positioning structure 330 of the electrical connector 33 with a second positioning structure 312 of the support 31 and connecting the first positioning structure 330 of the electrical connector 33 to the second positioning structure 312 of the support 31 to allow the electrical connector 33 to be positioned and mounted at the support 31.

In this way, through the engagement connection between the first positioning structure 330 of the electrical connector 33 and the second positioning structure 312 of the support 31, accurate positioning of the electrical connector 33 can be quickly realized, which reduces a duration of position finding and adjustment during the assembling, and thus significantly improves the assembling efficiency.

In an exemplary embodiment of the present disclosure, the first positioning structure 330 is a component of the electrical connector 33 for cooperation with the second positioning structure 312 of the support 31 to ensure the accurate positioning of the electrical connector 33 during the mounting. The first positioning structure 330 may be a protrusion, a groove, a hole, or other structures.

The second positioning structure 312 is a component of the support 31 for cooperation with the first positioning structure 330 of the electrical connector 33 to ensure the accurate positioning of the electrical connector 33 during the mounting. The second positioning structure 312 may be a groove, a protrusion, a hole, and other structures that are adapted to the first positioning structure 330.

In one example, the first positioning structure 330 is a protrusion, and the second positioning structure 312 is a hole. During assembling, the protrusion is inserted into the hole to complete the engagement connection between the first positioning structure 330 and the second positioning structure 312, thereby completing the positioning of the electrical connector 33.

Referring to FIG. 41, in some embodiments, the first positioning structure 330 is a protrusion, and the second positioning structure 312 is a positioning hole. The engaging the first positioning structure 330 of the electrical connector 33 with the second positioning structure 312 of the support 31 and connecting the first positioning structure 330 of the electrical connector 33 to the second positioning structure 312 of the support 31 includes:

inserting the protrusion into the positioning hole.

In this way, through the engagement of the protrusion and the positioning hole, a connection process of the electrical connector 33 and the support 31 is simpler, thereby reducing the assembling complexity. Furthermore, this method can lower the manufacturing costs since no additional connection elements (such as a screw and a bolt) are required.

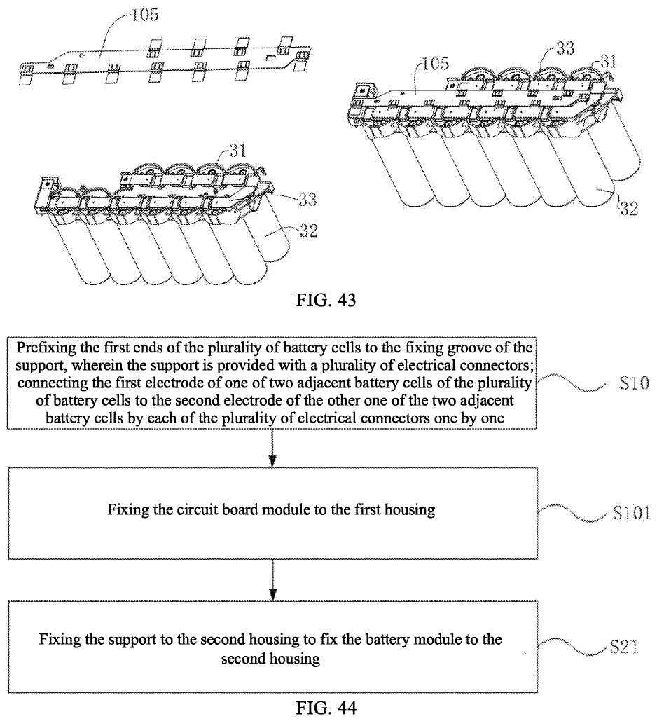

Referring to FIG. 43, in some embodiments, the assembling method further includes, prior to the mounting the battery module 30 to the shell 10:

mounting a collection assembly 105 to the support 31, and connecting the collection assembly 105 to the electrical connector 33.

In this way, the collection assembly 105 is pre-mounted at the support 31 and connected to the electrical connector 33, which reduces subsequent steps of complex wiring and mounting at the shell 10, and thus significantly improves the assembling efficiency.

In an exemplary embodiment of the present disclosure, the collection assembly 105 is a component for monitoring and collecting data of the battery module 30. The data includes, but is not limited to, a voltage, a current, a temperature, etc. The collection assembly 105 may include a voltage collection module, a temperature sensor, or a current sensor, etc. The collection component 105 may be mounted at the support 31 through buckle fixation, bolt fixation, adhesive fixation, etc.

Referring to FIGS. 5, 6, and FIG. 44, in some embodiments, the energy storage power supply 100 further includes a circuit board module 20. The shell 10 includes a first housing 11 and a second housing 12 that are separately formed. The second housing 12 has a mounting groove 121. The assembling method includes an action at block S101.

At block S101, the circuit board module 20 is fixed to the first housing 11. The fixing the support 31 to the shell 10 to fix the battery module 30 to the shell 10 (block S20) includes an action at block S21.

At block S21, the support 31 is fixed to the second housing 12 to fix the battery module 30 to the second housing 12.

In this way, the first housing 11 and the second housing 12 can serve as independent units of the circuit board module 20 and battery module 30, respectively. Such a modular design allows the battery module 30 and the circuit board module 20 to be assembled separately, simplifying the assembling process and improving the assembling efficiency.

In some embodiments, the assembling method further includes, subsequent to the fixing the support 31 to the second housing 12 to fix the battery module 30 to the second housing 12 includes:

connecting the battery module 30 to the circuit board module 20 through a wire harness, and assembling the first housing 11 and the second housing 12, to allow the battery module 30 and the circuit board module 20 to be located in the accommodation chamber 13 formed by the first housing 11 and the second housing 12.

In this way, the electrical connection step is performed prior to the assembling of the shell 10, which can avoid complex wiring and connection operations in a limited space of the shell 10, simplify the assembling process, and improve the assembling efficiency. Meanwhile, it is also convenient to check and adjust quality of the electrical connection.

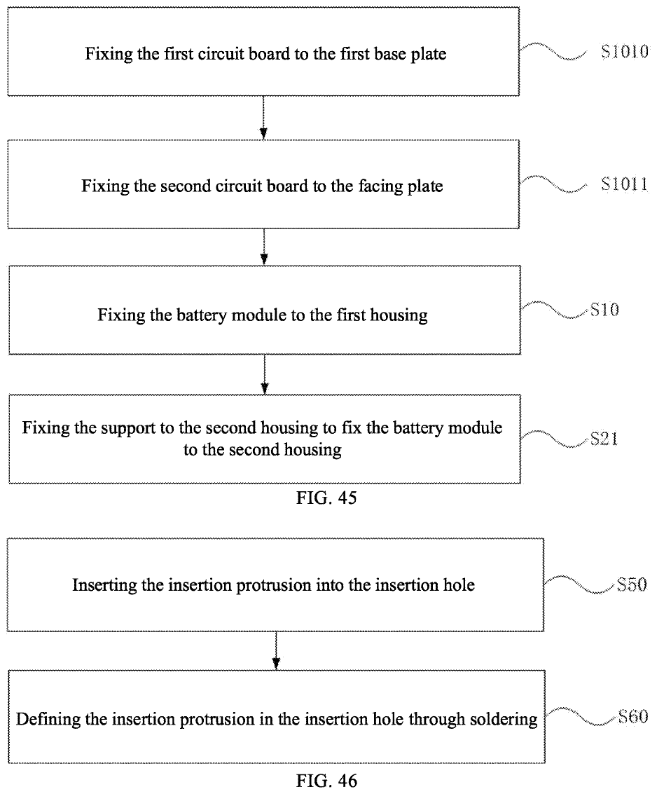

Referring to FIGS. 2, 9, and 45, in some embodiments, the first housing 11 includes a first base plate 111 and a facing plate 112 connected to the first base plate 111. The facing plate 112 is connected to the second housing 12. The circuit board module 20 includes a first circuit board 21 and a second circuit board 22 fixedly connected to the first circuit board 21. The first circuit board 21 and the second circuit board 22 are arranged at a certain angle.

The fixing the circuit board module 20 to the first housing 11 (block S101) includes actions at blocks S1010 and S1011.

At block S1010, the first circuit board 21 is fixed to the first base plate 111.

At block S1011, the second circuit board 22 is fixed to the facing plate 112.

In this way, by dividing the circuit board module 20 into the first circuit board 21 and the second circuit board 22, and fixing the first circuit board 21 and the second circuit board 22 to the first base plate 111 and the facing plate 112, respectively, the mounting and disassembling processes are more convenient. When maintaining or replacing the circuit board module 20, the corresponding circuit board can be operated independently, which reduces maintenance difficulty and lowers the costs, and improves maintenance efficiency.

In some embodiments, one of the first circuit board 21 and the second circuit board 22 has an insertion hole 210, and the other one of the first circuit board 21 and the second circuit board 22 is provided with an insertion protrusion 220. The assembling method includes actions at blocks S50 and S60.

At block S50, the insertion protrusion 220 is inserted into the insertion hole 210.

At block S60, the insertion protrusion 220 is retained in the insertion hole 210 through soldering.

In this way, through the engagement between the insertion protrusion 220 and the insertion hole 210, the mechanical connection between the first circuit board 21 and the second circuit board 22 is first realized. This preliminary fixation makes a positional relationship between the two circuit boards more stable, making it less likely to be offset during subsequent soldering, and improving assembling accuracy and stability.

After the insertion protrusion 220 is inserted into the insertion hole 210, the fixing is performed through soldering. Such a double connection method not only enhances strength of the mechanical connection, but also ensures reliability of the electrical connection. The soldering can provide good electrical conductivity, reduce contact resistance, and ensure stable electrical performance between the circuit boards.

The energy storage power supply 100 according to the embodiments of the present disclosure is manufactured by using the assembling method according to any one of the above embodiments.

At last, it should be noted that, the above embodiments are only used to illustrate, rather than to limit, the technical solutions of the present disclosure. Although the present disclosure has been described in detail with reference to the above embodiments, those skilled in the art should understand that modifications may be made to the technical solutions described in the above embodiments, or equivalent replacements may be made to some or all of the technical features of the technical solutions described in the above embodiments. However, these modifications or replacements do not cause the essence of corresponding technical solutions to deviate from the scope of the technical solutions of the embodiments of the present disclosure, and shall be included in the scope of the claims and the specification of the present disclosure. In particular, the technical features mentioned in the various embodiments can be combined in any way as long as there are no structural conflicts. The present disclosure is not limited to the specific embodiments disclosed herein, but includes all technical solutions falling within the scope implementations the claims.

What is claimed is:

1. An energy storage power supply, comprising:
a shell comprising a first housing and a second housing detachably connected to the first housing, the first housing and the second housing defining an accommodation chamber;
a circuit board module comprising an inverter circuit, the circuit board module being fixedly mounted in the accommodation chamber; and
a battery module fixedly mounted in the accommodation chamber, the battery module being electrically connected to the circuit board module,
wherein the battery module and the circuit board module are spaced apart from each other in a first direction of the accommodation chamber, the battery module having a first high region and a first low region that have a height difference in the first direction, and the circuit board module having a second high region and a second low region that have a height difference in the first direction, wherein the first high region and the second low region partially overlap in the first direction, wherein the first low region and the second high region partially overlap in the first direction, and wherein the first high region and the second high region partially overlap in a second direction, the second direction being perpendicular to the first direction.

2. The energy storage power supply according to claim 1, wherein the first housing has a ventilation opening in communication with the accommodation chamber.

3. The energy storage power supply according to claim 1, wherein the first housing comprises a first base plate and a facing plate connected to the first base plate, the facing plate being connected to the second housing, and at least part of the circuit board module being fixedly mounted at the first base plate.

4. The energy storage power supply according to claim 3, wherein the circuit board module comprises a first circuit board and a second circuit board electrically connected to the first circuit board, the first circuit board being fixedly mounted at the first base plate, and the second circuit board being fixed at the facing plate.

5. The energy storage power supply according to claim 4, wherein:
one of the first circuit board and the second circuit board has an insertion hole; and
the other one of the first circuit board and the second circuit board is provided with an insertion protrusion, the insertion protrusion being inserted into the insertion hole to enable the first circuit board to be fixedly connected to the second circuit board.

6. The energy storage power supply according to claim 4, wherein the second housing has an insertion slot, the second circuit board being inserted into the insertion slot at an edge of the second circuit board away from the first circuit board.

7. The energy storage power supply according to claim 4, wherein:
one of the first circuit board and the second circuit board is provided with a pin header; and
the other one of the first circuit board and the second circuit board is provided with a female header, the pin header being inserted into the female header to enable the first circuit board to be electrically connected to the second circuit board.

8. The energy storage power supply according to claim 4, wherein the first circuit board comprises a functional circuit, the functional circuit comprising a battery management circuit, an inverter circuit and a solar charging circuit, wherein:
the battery management circuit is electrically connected to the battery module and is configured to connect or disconnect an electric connection between the battery module and an external circuit;
the inverter circuit is electrically connected to the battery module via the battery management circuit and is configured to convert between an alternating current and a direct current; and
the solar charging circuit is electrically connected to the battery module via the battery management circuit and is configured to maximize electrical energy generated by a solar panel.

9. The energy storage power supply according to claim 4, wherein the second circuit board comprises an output circuit, the output circuit being configured to be electrically connected to an external circuit and outputting power.

10. The energy storage power supply according to claim 1, wherein:
the battery module comprises a support and a plurality of battery cells, each of the plurality of battery cells being mounted at the support at an end of the battery cell; and
the second housing has a plurality of mounting grooves, the battery cell being embedded into a corresponding mounting groove of plurality of mounting grooves at the other end of the battery cell, and the support being fixedly mounted at the second housing to fix the plurality of battery cells to the second housing.

11. The energy storage power supply according to claim 10, wherein the second housing comprises a second base plate and a second side plate connected to the second base plate, the plurality of mounting grooves being formed in the second side plate, and the second side plate being connected to the first housing.

12. The energy storage power supply according to claim 11, wherein the second base plate is provided with a support rib plate, the support rib plate having a limit groove, and the battery cell abutting with a groove wall of the limit groove.

13. The energy storage power supply according to claim 11, wherein:
the first housing comprises a first base plate and a facing plate connected to the first base plate, the facing plate being connected to the second housing, the first base plate being opposite to the second base plate, and the facing plate being opposite to the second side plate; and
the circuit board module comprises a first circuit board and a second circuit board electrically connected to the first circuit board, the first circuit board being fixedly mounted at the first base plate, and the second circuit board being fixed at the facing plate.

14. The energy storage power supply according to claim 10, wherein:
the battery cell has a first end and a second end in a length direction of the battery cell, a pressure relief structure being formed at the second end of the battery cell, and the battery cell being embedded into the corresponding mounting groove at the second end of the battery cell; and
each of the plurality of mounting grooves is internally provided with a support structure, the support structure abutting with the second end of the battery cell in such a manner that a gap is formed between the second end and a bottom of the mounting groove to form a pressure relief groove in communication with the accommodation chamber.

15. The energy storage power supply according to claim 10, wherein:
the battery cell has a first end and a second end in a length direction of the battery cell, the battery cell being provided with a first electrode and a second electrode at the first end of the battery cell; and
the battery module comprises an electrical connector, the first electrode of one of two adjacent battery cells of the plurality of battery cells being connected to the second electrode of the other one of the two adjacent battery cells by the electrical connector, wherein the second end of the battery cell is embedded into the corresponding mounting groove.

16. The energy storage power supply according to claim 1, wherein:
the circuit board module is fixedly mounted at the first housing; and
the battery module is fixedly mounted at the second housing.

17. The energy storage power supply according to claim 1, comprising a thermal insulation member disposed between the battery module and the circuit board module, the thermal insulation member covering the battery module.

18. The energy storage power supply according to claim 1, wherein the circuit board module is provided with a shielding member at a side of the circuit board module away from the battery module, the shielding member being configured for heat dissipation and/or electromagnetic interference shielding.

19. The energy storage power supply according to claim 1, wherein:
the first housing and the second housing are arranged in a height direction of the energy storage power supply, the first housing being disposed at a top of the second housing;
the circuit board module comprises a plate body and a functional element disposed at the plate body, the plate body being disposed at a top of the first housing, and the functional element being disposed at the plate body and facing towards the battery module.

20. An energy storage power supply, comprising:
a first housing assembly comprising a first housing and a circuit board module fixed at the first housing; and
a second housing assembly comprising a second housing and a battery module fixedly mounted at the second housing, the first housing and the second housing being detachably connected to each other and defining an accommodation chamber, and each of the circuit board module and the battery module being located in the accommodation chamber.
